(19) United States
(12) Patent Application Publication
(10) Pub. No.: US 2017/0108702 A1
(43) Pub. Date: Apr. 20, 2017

(54) NEAR-EYE DISPLAY SYSTEM

(71) Applicant: Cinema2Go Ltd., Yokneam Ilit (IL)

(72) Inventor: Arthur RABNER, Yokneam Ilit (IL)

(21) Appl. No.: 15/318,027

(22) PCT Filed: Jul. 14, 2015
(86) PCT No.: PCT/IL2015/050730

§ 371 Date: Dec. 12, 2016

Related U.S. Application Data
(60) Provisional application No. 62/024,171, filed on Jul. 14, 2014.
(60) Provisional application No. 62/137,623, filed on Mar. 24, 2015.

(51) Int. Cl. G02B 27/22; G02C 11/00; G02C 7/14; G02B 27/02; G02C 7/02

(52) U.S. Cl. CPC G02B 27/2242; G02B 27/027; G02C 7/02; G02C 7/14; G02B 27/2264; G02B 27/2235; G02C 11/10

(57) ABSTRACT

An optical magnification is disclosed. The system comprises: a structure having a frame configured to removably secure a display device thereto; and a pair of spaced apart ocular systems, mounted on the structure in front of the frame for providing a view of the display device once mounted on the frame; wherein each of the ocular systems has an aspheric optical surface and provides a prismatic refraction.

### RELATED APPLICATION

This application claims the benefit of priority of U.S. Provisional Patent Application Nos. 62/024,171, filed Jul. 14, 2014, and 62/137,623, filed Mar. 24, 2015, the contents of which are incorporated herein by reference in their entirety.

### FIELD AND BACKGROUND OF THE INVENTION

The present invention, in some embodiments thereof, relates to personal display system and, more particularly, but not exclusively, to a near-eye display system.

Three dimensional (3D) images are increasingly used to display vivid images in movies, electronic games and in other applications. For example 3D movies are displayed in theatres and are viewed by persons equipped with special 3D glasses. Additionally, 3D movies and electronic games may be displayed on specially equipped televisions or computer displays for viewing by persons equipped with special 3D glasses.

The basic approach to displaying 3D images is to display two slightly offset images separately to the left and right eye. The two principal strategies have been used to accomplish this are: (1) for the viewer to wear a special 3D eyepiece that filters each offset image to a different eye; and (2) to split the light source directionally into each of the viewer's eyes, thus eliminating the need for special glasses.

One increasingly common approach to projecting stereoscopic image pairs is a head mounted display system that mounts to a person's head and that displays a virtual image on an attached eyepiece. Head mounted displays are often used in simulators or for games, though they can also be used to view media such as movies or digital photos.

### SUMMARY OF THE INVENTION

According to an aspect of some embodiments of the present invention there is provided an optical magnification system. The system comprises: a structure having a frame configured to removably secure a display device thereto; and a pair of spaced apart ocular systems, mounted on the structure in front of the frame for providing a view of the display device once mounted on the frame; wherein each of the ocular systems has an aspheric optical surface and provides a prismatic refraction.

According to some embodiments of the invention the aspheric optical surface and the optically opposite surface are spaced apart from each other at a nasal portion of a periphery of the lens by a cut through a thickness thereof.

According to some embodiments of the invention the system comprises: a pair of controllable light shutters respectively positioned between the ocular systems and the frame; and a controller having a circuit configured for receiving synchronization signal from the display device and activating and deactivating the light shutters in an alternating manner, responsively to the synchronization signal.

According to some embodiments of the invention the system comprises an ocular manipulation assembly configured for displacing and rotating each of the ocular systems.

According to some embodiments of the invention the each of the ocular systems comprises a lens having the aspheric surface and at least one prismatic element positioned in front of the lens and being separated from the lens.

According to some embodiments of the invention the ocular manipulation assembly is configured to rotate also the prismatic element, and wherein the rotation is reciprocally from a first state at which each ocular system focus all light rays from the display device, to a second state at which the prismatic elements block a left light beam from a left part of the display device from arriving at a lens of a right ocular system of the pair, and a right light beam from a right part of the display device from arriving at a lens of a left ocular system of the pair.

According to some embodiments of the invention ocular manipulation assembly is configured to vary a distance between the ocular systems and the frame, wherein the distance is larger at the first state of the ocular systems than at the second state of the ocular systems.

According to some embodiments of the invention the ocular manipulation assembly is controllable mechanically.

According to some embodiments of the invention the ocular manipulation assembly is controllable electronically.

According to some embodiments of the invention the frame and the ocular systems are arranged such that light beams from the display device directly arrive to at least one of the ocular systems.

According to some embodiments of the invention the system comprises at least one pair of reflective optical elements configured for redirecting light beams from the display device respectively onto the pair of ocular systems.

According to some embodiments of the invention the frame is mounted on the structure such that when the structure is head mounted in an upright position, the frame is tilted with respect to a vertical direction.

According to some embodiments of the invention the frame is mounted on the structure such that when the structure is head mounted in an upright position, the frame is generally vertical.

According to some embodiments of the invention the structure comprises a variable length support element for supporting the frame at an adjustable optical distance from the pair of ocular systems, and wherein the ocular systems are configured to adjust a focal distance thereof responsively to a variation of the optical distance.

According to some embodiments of the invention the structure comprises a variable length support element for supporting the frame at an adjustable optical distance from the pair of ocular systems, and wherein, responsively to a variation of the optical distance, the ocular systems adjust a focal distance thereof, and wherein the ocular manipulation assembly actuates the displacement and the rotation.

According to an aspect of some embodiments of the present invention there is provided a method of an image, the method comprises securing a display device to the system, placing the structure near the eyes, and viewing the display device through the ocular systems.

According to an aspect of some embodiments of the present invention there is provided a method of viewing an image displayed on a display device, the method comprises: securing the display device to a structure having a frame configured to secure the display device thereto; mounting the structure on a head; and viewing the image through a pair of spaced apart ocular systems mounted on the structure in front of the frame, wherein each of the ocular systems has an aspheric optical surface and provides a prismatic refraction.

According to some embodiments of the invention the image is a three-dimensional video image having an alternating sequence of images for left and right views, and the method comprises receiving synchronization data from the display device and, responsively to the synchronization signal, activating and deactivating a pair of controllable light shutters respectively positioned between the ocular systems and the frame, in an alternating manner corresponding to the alternating sequence.

According to some embodiments of the invention the system comprises displacing and rotating each of the ocular systems.

According to some embodiments of the invention the displacement and the rotation is reciprocally from a first state at which central optical paths of the ocular systems converge, to a second state at which the central optical paths are generally parallel to each other.

According to some embodiments of the invention the each of the ocular systems comprises a lens having the aspheric surface and at least one prismatic element positioned in front of the lens and being separated from the lens.

According to some embodiments of the invention the method comprises reciprocally rotating also the prismatic element from a first state at which each ocular system focus all light rays from the display device, to a second state at which the prismatic elements block a left light beam from a left part of the display device from arriving at a lens of a right ocular system of the pair, and a right light beam from a right part of the display device from arriving at a lens of a left ocular system of the pair.

According to some embodiments of the invention the method comprises varying a distance between the ocular systems and the frame, wherein the distance is larger at the first state of the ocular systems than at the second state of the ocular systems.

According to some embodiments of the invention the structure comprises a variable length support element for supporting the frame, and the method comprises adjusting an optical distance from the pair of ocular systems to the frame, and also adjusting a focal distance thereof responsively to a variation of the optical distance.

According to an aspect of some embodiments of the present invention there is provided a display system comprises: a structure having a frame configured to removably secure thereto a left display device and a right display device in a tilted relationship therebetween; and a left ocular system and right ocular system, mounted on the structure in front of the frame such that central optical paths of the ocular systems diverge towards the frame to respectively provide enlarged views of the left and the right display devices; wherein each of the ocular systems has an aspheric optical surface and provides a prismatic refraction.

According to some embodiments of the invention the aspheric optical surface and the optically opposite surface are spaced apart from each other at a temporal portion of a periphery of the lens by a cut through a thickness thereof.

According to some embodiments of the invention the system wherein each of the ocular systems is a lens having prismatic shape.

According to some embodiments of the invention a second optical surface of the lens, optically opposite to the aspheric optical surface, is generally planar or spherical.

According to some embodiments of the invention a second optical surface of the lens, optically opposite to the aspheric optical surface, is also aspheric.

According to some embodiments of the invention the system according to any wherein each of the ocular systems comprises a lens having the aspheric surface and at least one prismatic element positioned between the lens and the frame or behind of the lens.

According to some embodiments of the invention the system according to any wherein each of the ocular systems is diffractive.

According to some embodiments of the invention the system comprises a controller having a circuit for controlling the display devices to display different portions of an image having a left periphery, a binocular overlap and a right periphery, wherein the left display device displays the left periphery and the binocular overlap, and the right display device displays the binocular overlap and the right periphery.

According to some embodiments of the invention the controller comprises a user interface and wherein circuit is configured for shifting a location of the binocular overlap over at least one of the display devices, responsively to a user input received by the user interface.

According to some embodiments of the invention the system comprises a separator device mounted on the structure along a symmetry line between the left and the right display devices to block light beams from the left display device from arriving at the right ocular system, and light beams from the right display device from arriving at the left ocular system.

According to some embodiments of the invention the separator device comprises a back-to-back pair of auxiliary display devices, and wherein light beams from a left auxiliary display device of the pair arrive at the left ocular system, and light beams from a right auxiliary display device of the pair arrive at the right ocular system.

According to some embodiments of the invention the circuit is configured to control the left auxiliary display device to display the right periphery, and the right auxiliary display device to display the left periphery.

According to some embodiments of the invention the system comprises: a pair of controllable light shutters respectively positioned between the ocular systems and the frame; and a controller having a circuit configured for receiving synchronization signal from the display device and activating and deactivating the light shutters in an alternating manner, responsively to the synchronization signal.

According to some embodiments of the invention the structure comprises a variable length support element for supporting the frame at an adjustable optical distance from the pair of ocular systems, and wherein the ocular systems are configured to adjust a focal distance thereof responsively to a variation of the optical distance.

According to some embodiments of the invention at least one of the each of the ocular systems comprises a vision correction lens.

According to some embodiments of the invention each of the each of the ocular systems comprises a vision correction lens, and wherein a refractive power of a vision correction lens of a first lens system of the pair differ from a refractive power of a vision correction lens of a second lens system of the pair.

According to an aspect of some embodiments of the present invention there is provided a method of viewing an image, the method comprises securing a left display device and a right display device to the system, placing the structure near the eyes, and viewing the display devices through the ocular systems.

According to an aspect of some embodiments of the present invention there is provided a method of viewing an image displayed on a left display device and a right display device, the image having a left periphery, a binocular overlap and a right periphery, the method comprises: securing the display devices to a structure having a frame configured to receive the display devices in a tilted relationship therebetween; mounting the structure on a head; and viewing the left periphery through a left ocular system, the right periphery through a right ocular system, and the binocular overlap through at least one of the left and the right ocular systems; wherein central optical paths of the ocular systems diverge towards the display devices, and wherein each of the ocular systems has an aspheric optical surface and provides a prismatic refraction.

According to some embodiments of the invention the method comprises shifting a location of the binocular overlap over at least one of the display devices to correct for diplopya.

According to some embodiments of the invention the viewing comprises viewing the left periphery and the binocular overlap through the left ocular system, and the binocular overlap and the right periphery through the right ocular system.

According to some embodiments of the invention the system comprises viewing a left auxiliary display device displaying the right periphery, and a right auxiliary display device displaying the left periphery, wherein the auxiliary display devices are arranged in a back-to-back arrangement along a symmetry line between the left and the right display devices.

According to some embodiments of the invention the binocular overlap is displayed on the left and the right display devices in an alternating manner and, wherein the viewing comprises alternating between viewing the left display device when the binocular overlap is displayed on the left display device, and viewing the right display device when the binocular overlap is displayed on the right display device.

According to an aspect of some embodiments of the present invention there is provided a display system for displaying a stereoscopic image having a stereoscopic left periphery, a stereoscopic binocular overlap and a stereoscopic right periphery, the system comprises: a structure having a frame configured to removably secure a display device thereto; a plurality of auxiliary display devices each mounted on the structure at an angle to a plane engaged by the frame, the auxiliary display devices including at least a left auxiliary display device and a right auxiliary display device; a left ocular system and right ocular system, mounted on the structure in front of the frame and the auxiliary display devices, wherein a field-of-view of the left ocular system includes the left auxiliary display device, and field-of-view of the right ocular system includes the right auxiliary display device; and a controller having a circuit configured to display (i) a left-eye image of the stereoscopic left periphery on the left auxiliary display device, (ii) a left-eye image and a right-eye image of the stereoscopic binocular overlap on the display device in a side-by-side configuration, and (iii) a right-eye image of the stereoscopic right periphery on the right auxiliary display device.

According to some embodiments of the invention the system wherein the plurality of auxiliary display devices comprises a central-left auxiliary display device and a central-right auxiliary display device, and wherein the circuit is configured to display (iv) a right-eye image of the stereoscopic left periphery on the central-right auxiliary display device, and (v) a left-eye image of the stereoscopic right periphery on the central-left auxiliary display device.

According to an aspect of some embodiments of the present invention there is provided a method of viewing a stereoscopic image, the method comprises securing a display device to the system, mounting the structure on a head, and viewing the display device and the auxiliary display devices through the ocular systems.

According to an aspect of some embodiments of the present invention there is provided a method varying an aspect ratio of an image, the method comprises; identifying on the image a first region and at least one additional region; processing the image to resize the at least one additional region along at least one dimension, while maintaining an aspect ratio of the first region substantially unchanged, thereby varying the an aspect ratio of the image; and transmitting the image to a display system.

According to some embodiments of the invention the method wherein the processing comprises varying an aspect ratio of the at least one additional region.

According to some embodiments of the invention the method wherein the processing comprises resizing the second region while preserving an aspect ratio thereof.

According to some embodiments of the invention the identifying the at least one additional region comprises identifying a second region and a third region.

According to some embodiments of the invention the first region is a central region of the image, and the at least one additional region is a peripheral region of the image.

According to an aspect of some embodiments of the present invention there is provided a display system for augmented reality, the system comprises: a structure having a frame configured to removably secure a display device thereto, such that when the structure is mounted on a head, the frame is above the eyes; and an optics assembly mounted on the structure and being partially reflective and partially transmissive for simultaneously providing a view of an image displayed on the display device and a view of an environment outside the structure.

According to some embodiments of the invention the system wherein the optics assembly is configured to converge light beams arriving from the display device but not light beams arriving from the environment.

According to some embodiments of the invention the structure comprises a variable length support element for supporting the frame at an adjustable optical distance from the optics assembly, thereby to effect focal distance adjustment for the light beams arriving from the display device.

According to some embodiments of the invention the frame is mounted on the structure such that when the structure is head mounted in an upright position, the frame is tilted with respect to a vertical direction.

According to some embodiments of the invention the frame is mounted on the structure such that when the structure is head mounted in an upright position, the frame is generally vertical.

According to some embodiments of the invention the optics assembly comprises a reflecting element for light beams arriving from the environment onto a back side of the display device.

According to an aspect of some embodiments of the present invention there is provided an augmented reality method, comprises mounting a display device on the system, placing the structure near the eyes, and viewing the display device and the environment using the optics assembly.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a side-by-side, near eye 3D display;

FIG. 2 is a schematic illustration showing a side view of an optical magnification system, according to some embodiments of the present invention;

FIG. 3A is a schematic illustration of a top view of the optical magnification system, according to some embodiments of the present invention;

FIGS. 3B and 3C are schematic illustrations showing exemplary implementations of ocular systems, according to some embodiments of the present invention;

FIGS. 4A-D are schematic illustrations of embodiments in which each ocular system comprises a plurality of optical elements;

FIG. 5 is a schematic illustration of the system in embodiments of the invention in which the ocular systems comprise a vision correction lens;

FIGS. 6A and 6B are schematic illustration of in embodiments of the invention in which an image is separated into an alternating field sequence;

FIGS. 7A-D are schematic illustrations of the system in embodiments of the invention in which an image is displayed in a side-by-side configuration;

FIGS. 8A-D are schematic illustrations of the system in embodiments of the invention in which each of the ocular systems comprises a lens having the aspheric surface and a prismatic element positioned in front of the lens and being separated from the lens;

FIG. 9 is a schematic illustration of the system in embodiments of the invention in which the system comprises add-on positive lenses;

FIGS. 10A-E are schematic illustrations of the system in embodiments of the invention in which reflective optical elements redirect light beams from the display device onto the ocular systems;

FIGS. 11A-C are schematic illustrations of the system in embodiments of the invention in which the system comprises a variable length support element for supporting a frame at an adjustable optical distance from the ocular systems;

FIG. 12 is a schematic illustration of a display system, according to some embodiments of the present invention;

FIGS. 13A and 13B are schematic illustrations of an image (FIG. 13A) and the different portions of the image on two display devices (FIG. 13B), according to some embodiments of the present invention;

FIG. 14 is a schematic illustration of a configuration in which the system provides a 24:9 view using two 16:9 display devices, according to some embodiments of the present invention;

FIGS. 15A and 15B are schematic illustrations of the system in embodiments of the invention in which the systems corrects for muscular imbalance or eccentric fixation by the eyes;

FIG. 16 illustrates the system in embodiments of the invention in which the system comprises a separator device;

FIGS. 17A and 17B are schematic illustrations of the system in embodiments of the invention in which the system comprises controllable light shutters;

FIG. 18 is a schematic illustration of a display system which comprises side auxiliary display devices, according to some embodiments of the present invention;

FIG. 19 is a schematic illustration of a display system in embodiments in which the system comprises four auxiliary display devices, according to some embodiments of the present invention;

FIG. 20 is a schematic illustration of a representative implementation in which a 21:9 aspect ratio 3D image is provided using a 16:9 display, according to some embodiments of the present invention;

FIG. 21A-C are schematic illustrations of a display system useful for augmented reality, according to some embodiments of the present invention;

FIGS. 22A-D are schematic illustrations of a method suitable for varying an aspect ratio of an image, according to some embodiments of the present invention;

FIG. 23A is a schematic illustration of a graph showing nonlinear or piecewise linear aspect ratio transformation, according to some embodiments of the present invention;

FIG. 23B is a schematic illustration of representative implementation example in which an aspect ratio of an input image is transformed from 16:9 to a combination of 2:9, 4:9 and 2:9 forming an output aspect ratio of 8:9;

FIG. 24 is a schematic illustration describing design considerations, according to some embodiments of the present invention; and

FIG. 25 is a schematic illustration of an electronic circuitry layout that can be used by a controller, according to some embodiments of the present invention.

### DESCRIPTION OF SPECIFIC EMBODIMENTS OF THE INVENTION

The present invention, in some embodiments thereof, relates to personal display system and, more particularly, but not exclusively, to a near-eye display system.

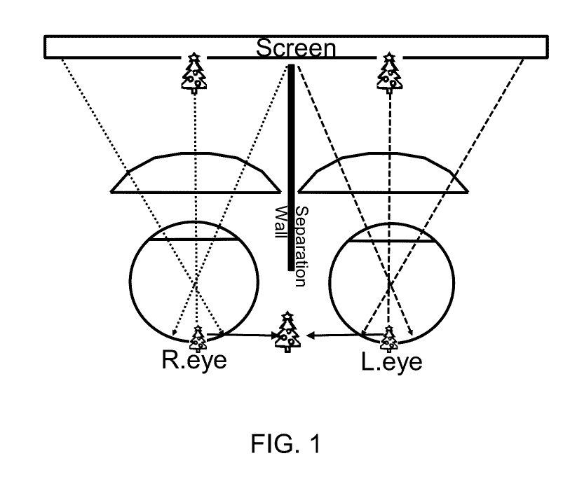

For purposes of better understanding some embodiments of the present invention, reference is first made to the construction and operation of a side-by-side, near eye 3D display as illustrated in FIG. 1. The display divides the screen to left and right parts such that each eye receives half screen correspondingly.

A portable or mobile electronics device, referred to hereinbelow as a mobile device, such as a smartphone, is capable of generating and displaying a stereoscopic or 3D movie or image that when projected onto an eyepiece appears to a viewer to have depth. This approach offers a low cost, mobile, solution to viewing 3D images since mobile electronics devices such as smartphones are widespread and relatively inexpensive. Therefore, it would be desirable to able to attach a mobile device to a head mounted display that properly displays 3D images or movies on an attached eyepiece.

It was found by the present inventor that regular Operating System (OS) and 2D content cannot be viewed using the system shown in FIG. 1. In order to operate such a system to view 2D content a special software layer above the OS is required. Alternatively, the operator is required to remove the smartphone from the display system and view the content not through the display system. Therefore, the operation of such display systems is uncomfortable and is limited to side-by-side contents.

Some embodiments of the present invention successfully provide a system that provide a field-of-view of at least 100° or at least 120° or at least 140° or at least 160°, and optionally also allows switching from full screen view into a side-by-side 3D view. As a representative example, which is not intended to be limiting, the system of the present embodiments can provide a field-of-view that is equivalent to an unaided view of a 50″ display from a distance of about half a meter. In full screen view, the system of the present embodiments optionally and preferably allows regular usage of the mobile electronics device while mounted on the system.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

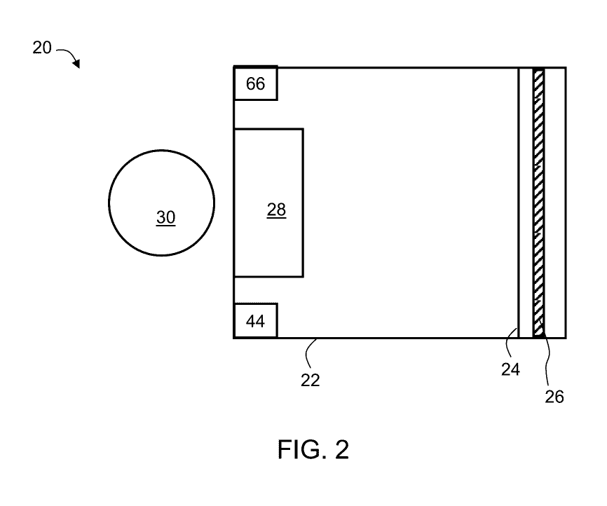

FIG. 2 is a schematic illustration showing a side view of an optical magnification system 20, according to some embodiments of the present invention. System 20 comprises a structure 22 which optionally and preferably has a frame 24 configured to removably secure a display device 26 thereto. Structure 22 is preferably portable. In some embodiments of the present invention structure 22 is head-mountable, some embodiments of the present invention structure 22 is wearable, and in some embodiments of the present invention structure 22 is hand-held. Structure 22 can also be on mechanical adjustable arm or other type of support.

As used herein “removably secure” describes a configuration in which an object (e.g., a display device) can be attached and detached from a structure (e.g., a frame), in a manner such that when the object is attached any displacement of the object relative to the structure is substantially prevented (e.g., with a tolerance of less than 1 mm).

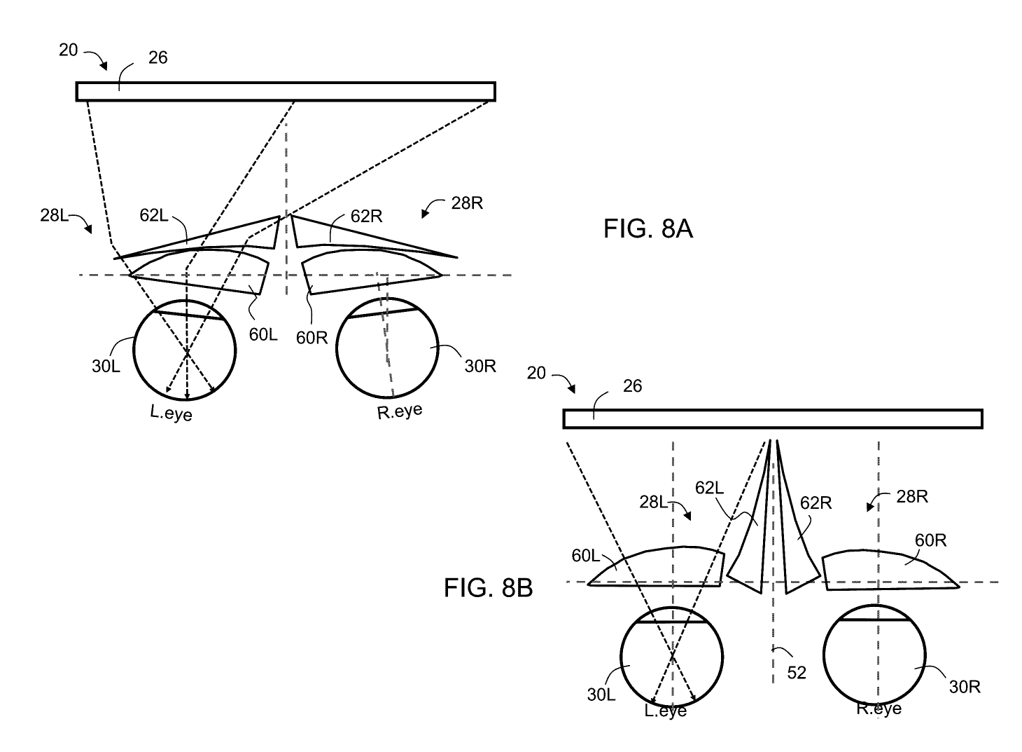

In various exemplary embodiments of the invention system 20 comprises a pair of spaced apart ocular systems 28, mounted on structure 22 in front of frame 24 for providing a view of display device 26 once mounted on frame 24. In various exemplary embodiments of the invention the central optical paths of systems 28 (not shown in the side view of FIG. 2, see, e.g., FIG. 7A) converge away from system 28 towards frame 24.

The collection of all light rays originating from the center of a binocular overlap region of the display device, once mounted on frame 24, and propagating toward a particular ocular system is referred to as a central light beam. In system 20, the binocular overlap region is optionally and preferably at the center of the display device, once mounted on frame 24.

As used herein “central optical path” of a particular ocular system refers to a path along which a light ray that is central with respect to the central light beam propagates.

It was found by the present Inventor that convergence of the central optical paths allows each of ocular systems 28 to provide a view of the entire screen of display device 26 while maintaining a relatively short distance between ocular systems 28 and device 26. System 20 optionally and preferably also comprises a controller 44, which typically includes a dedicated circuit configured to communicate with device 26 as further detailed hereinbelow.

In an exemplified use of system 20, the operator secures a display device 26, such as, but not limited to, a cellular phone, a smartphone, a portable media player, a portable gaming device, a portable digital assistant device, a portable navigation device and the like, to frame 24, places structure 22 such that ocular systems 28 are in front of the of user's eyes 30 which receive the views provided by ocular systems 28. The view of display FIG. 2 illustrates a side view of system 20 and therefore illustrates ocular systems 28 as a single device. A more detailed description of the principles and operations of ocular systems 28 is described below.

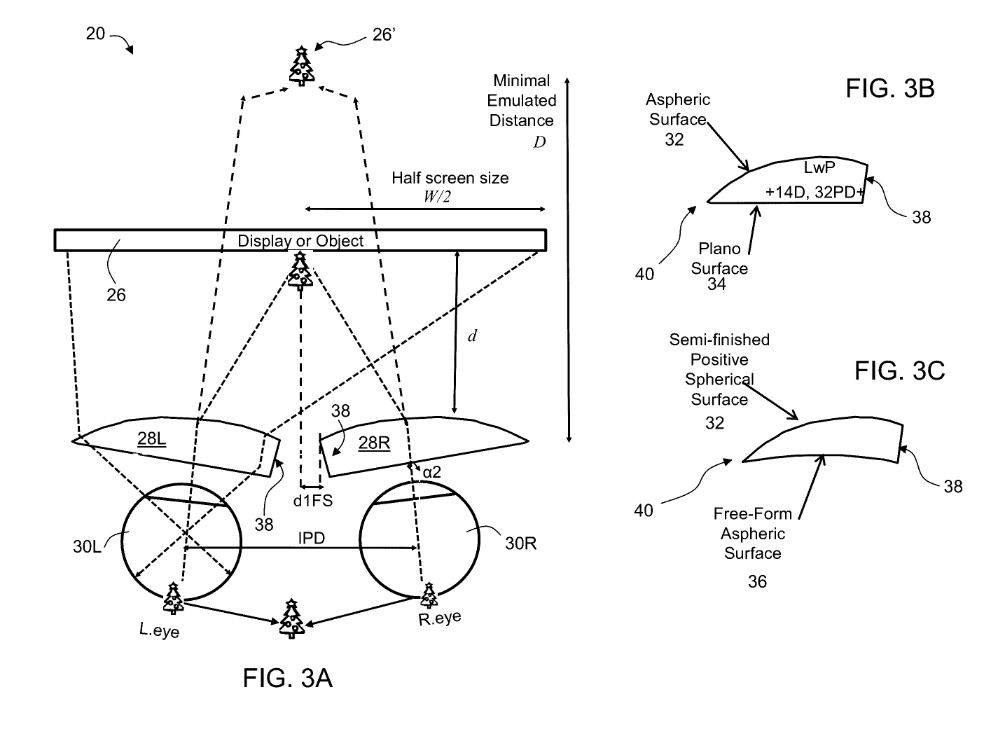

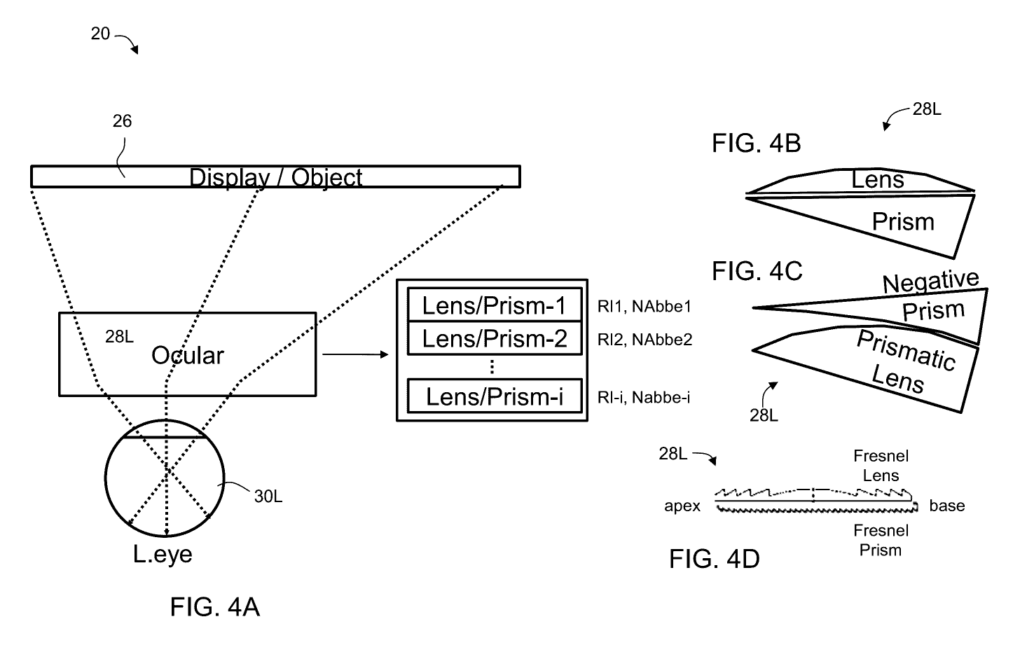

FIG. 3A illustrate a top view of system 20, according to some embodiments of the present invention. Shown are a left-eye ocular system 28L and right-eye ocular system 28R once placed in front of a left eye 30L and right eye 30R. For a display device having a width W of about 120 mm, the distance d between ocular systems 28 and device 26 is preferably from about 60 mm to about 80 mm, e.g., about 70 mm. The minimal emulated distance D between ocular systems 28 and the image 26′ of device 26 is preferably from about 200 mm to about 300 mm, e.g., about 250 mm. System 20 is optionally and preferably designed for an average inter-pupillary distance (IPD) of about 64 mm, and for a minimal IPD of about 50 mm. In FIG. 3A, d1FS denotes the spacing between ocular systems 28L and 28R for smaller IPD. Thus, in some embodiments of the present invention systems 28L and 28R are movable so as to adjust for different IPD. An assembly suitable for manipulating systems 28 that is described below can also be utilized, mutatis mutandis, to adjust for different IPD.

In various exemplary embodiments of the invention each of ocular systems 28L and 28R has an aspheric optical surface and provides a prismatic refraction. In some embodiments of the present invention at least one of lenses 28 comprise a single positive lens with prismatic addition (LwP), and in some embodiments of the present invention at least one of lenses 28 comprises a combination of LwP with a prism. Also contemplated are embodiments in which one or more of ocular systems 28 employs a progressive addition lens, e.g., for compensating for distance difference between the ocular systems 28 and different regions over display device 26.

In the illustration of FIG. 3A, each of ocular systems 28L and 28R is a lens having prismatic shape.

Exemplary implementations for ocular systems 28L and 28R are illustrated in FIGS. 3B and 3C. FIG. 3B shows a lens that has an aspheric surface 32 and a planar surface 34 which is optically opposite to aspheric surface 32. These embodiments are particularly useful when it is desired to make lenses 28 using injection molding. FIG. 3C shows a lens in which aspheric surface 32 is semi-finished, wherein the surface 36 that is optically opposite to aspheric surface 32 is also aspheric. These embodiments are particularly useful for free-form customization per refraction condition using optical semi-finished blank.

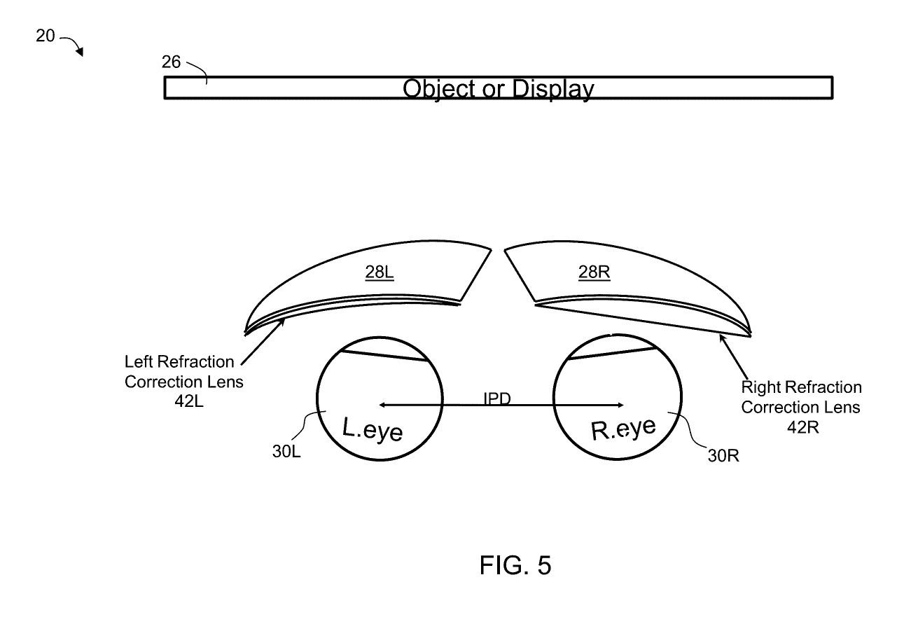

FIGS. 4A-D are schematic illustrations of embodiments in which each ocular systems 28 comprises a plurality of optical elements. For clarity of presentation, only ocular system 28L is illustrated. FIG. 4A illustrates an embodiment in which at least one of the ocular systems comprises a plurality of optical elements denoted as Lens/Prism-1 through Lens/Prism-i. Each of the elements can have a different combination of Refraction Index (RI) and Abbe number (NAbbe). Alternatively, at least one of the ocular systems can employ gradient-index (GRIN) optics. The advantage of these embodiments are that the variable optical properties of the ocular system can reduce or minimize chromatic aberrations. Several configurations of the present embodiments are illustrated in FIGS. 4B-4D, where FIG. 4B illustrates an embodiment in which the ocular system comprises a lens having aspheric surface and at least one prismatic element positioned between behind the lens (between the lens and the eye), FIG. 4C illustrates an embodiment in which the ocular system comprises a lens having aspheric surface and at least one prismatic element positioned in front of the lens (between the lens and the frame), and FIG. 4D illustrates an embodiment in which the ocular system employs diffractive optics (e.g., a stack including a Fresnel prism and a Fresnel lens).

In any of the above embodiments, for any of ocular systems 28L and 28R the aspheric surface of the lens and the optically opposite surface of the lens are preferably spaced apart from each other at a nasal portion of a periphery of the lens by a cut 38 (see FIGS. 3A-C) through a thickness thereof. Specifically, while the two surfaces of the lens (e.g., surfaces 32 and 34 in FIG. 3B, or surfaces 32 and 36 in FIG. 3C) are connected generally continuously 40, for example, at the temporal side of the lens, they are discontinued by cut 38 at the nasal side. The advantage of these embodiments is that it reduces weight and also provides space for the nose of the wearer. The cut is optionally and preferably parallel to marginal rays so as to reduce optical field losses.

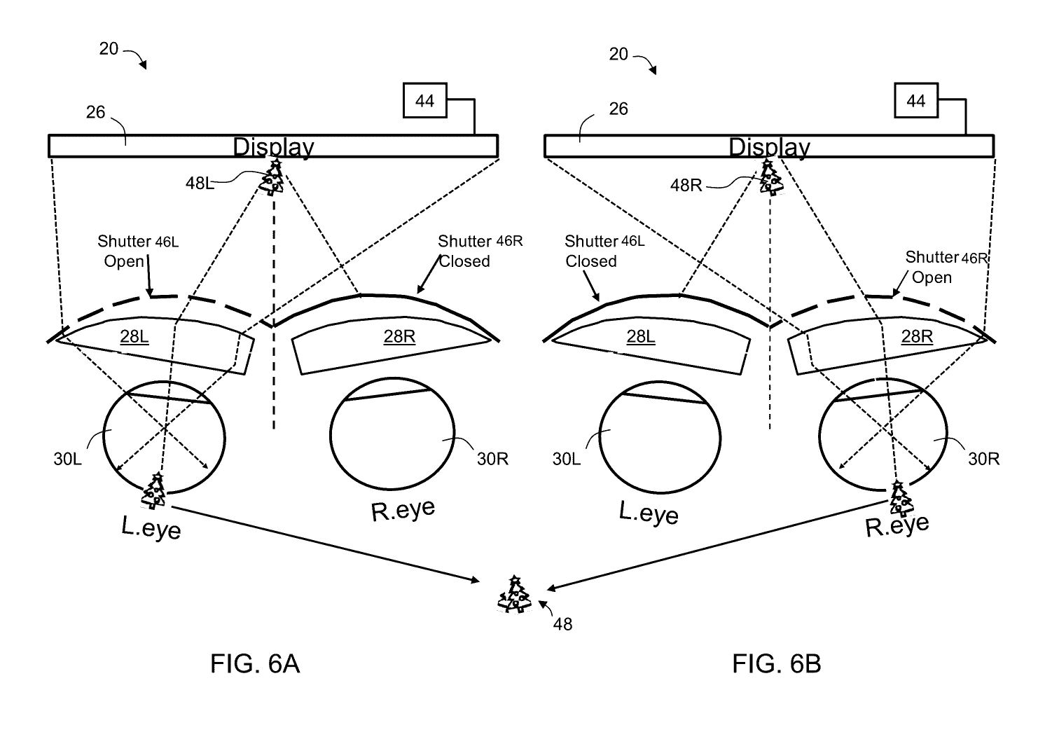

The present embodiments also contemplate configuration in which one or more of ocular systems 28 comprise a vision correction lens. These embodiments are illustrated in FIG. 5. In the illustrated embodiments, which is not to be considered as limiting, each of ocular systems 28L and 28R comprises a vision correction lens 42L and 42R, respectively, wherein a refractive power of vision correction lens 42L of system 28L differs from a refractive power of vision correction lens 42R of system 28R. Embodiments in which only one of the systems 28L and 28R comprise a vision correction, and embodiments in which both systems 28L and 28R comprise vision correction lenses with the same refractive power are also contemplated.

In various exemplary embodiments of the invention system 20 is used for viewing a 3D image, optionally and preferably a stereoscopic image. This can be done in more than one way.

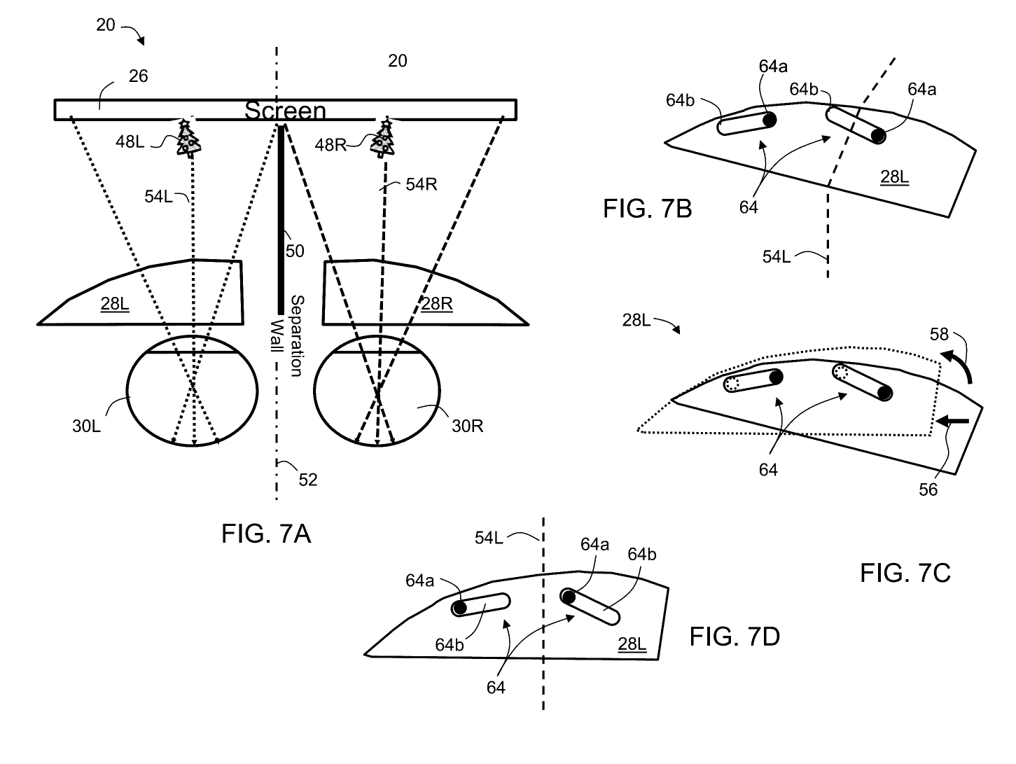

In some embodiments, illustrated in FIGS. 6A and 6B, the stereoscopic 3D image is separated into an alternating field sequence, where the stereoscopic 3D image includes a left-eye image 48L and a right-eye image 48R fields in a single frame. Preferably, the frame occupies the entire area of device 26. The alternating field sequence of the left-eye and right-eye images is displayed on display device 26. Controller 44 receives a synchronization signal from display device 26 and actively controls viewing for left and right eyes based on the synchronization signal. This can be done, for example, by means of a pair of controllable light shutters 46L and 26R respectively positioned between ocular systems 28L and 28R and display device 26. Referring more specifically to FIGS. 6A and 6B, when shutter 46L is open and shutter 46R is closed (FIG. 6A), only left eye 30L receives a view of display device 26. At these times, display device 26 displays frames of the left-eye image. Conversely, when shutter 46R is open and shutter 46L is closed (FIG. 6B), only right eye 30R receives a view of display device 26. At these times, display device 26 displays frames of the right-eye image.

The left-eye image and right-eye image are preferably alternating at a rate that is at least twice the rate of a two-dimensional video image (for example, twice a rate of 60 Hz), so that each eye receives a frame sequence at a rate of a two-dimensional video image, thus providing an illusion of a stereoscopic view, as if the left-eye image and the right-eye image are viewed simultaneously for each frame. The generated stereoscopic view is shown at 48.

In some embodiments, a side-by-side configuration is employed, wherein the left-eye image 48L and right-eye image 48R are displayed simultaneously on display device 26, but are spatially separated from each other. A left part of the screen of device 26 (typically the left half) displays image 48L and a right part of the screen device 26 (typically the right half) displays image 48R, as illustrated in FIG. 7A. A separator device 50, such as, but not limited to, an opaque wall is optionally mounted on structure 22 (not shown in FIG. 7A, see FIG. 2) along a symmetry line 52 between the left and right parts of display device 26, so as to block light beams from the left part from arriving at right ocular system 28R, and light beams from the right part from arriving at left ocular system 28L.

A side-by-side configuration is preferably achieved arranging said ocular systems 28 such that their central optical paths 54L and 54R are generally parallel (e.g., with a deviation from parallelism of less than 5° or less than 4° or less than 3° or less than 2° or less than 1°) to each other. This arrangement differs from the arrangement in which the central optical paths converge such that each ocular system provides a view of the entire screen of device 26. Thus, in various exemplary embodiments of the invention each of ocular systems 28 is spatially manipulated so as to switch from a full screen view to a side-by-side view. The process is illustrated in FIGS. 7B-D, for left ocular system 28L. One of ordinary skills in the art, provided with the details described herein would know how to adjust the process for ocular system 28R.

FIG. 7B illustrates a first state of ocular system 28L which is suitable for a full screen view, wherein the central optical paths 54L and 54R converge, as further detailed hereinabove, and FIG. 7D illustrates a second state of ocular system 28L which is suitable for a side-by-side view, wherein the central optical paths 54L and 54R are parallel to each other, as further detailed hereinabove. The spatial manipulation between the states is illustrated in FIG. 7C, showing the spatial relation between the first state (solid line) and the second state (dashed line). As illustrated, the spatial manipulation includes a combination of displacement 56 and a rotation 58, wherein for transition from the first state (full screen view) to the second state (side-by-side view) the displacement and rotation is towards the temporal side, and for the opposite transition the displacement and rotation is towards the nasal side.

The spatial manipulation is preferably effected by an ocular manipulation assembly 64 that displaces and rotates each of ocular systems 28L and 28R. Ocular manipulation assembly 64 can include a set of pins 64a and corresponding guide slots 64b, wherein the manipulation from one state to the other is by establishing relative sliding motion of pins 64a within guide slots 64b. FIGS. 7B-C show a configuration in which pins 64a are movable and slots 64b are static. Alternatively, pins 64a can be made static and slots 64b movable. In any event, the movable part of assembly 64 is preferably attached to or formed on the body of the lenses 28, and the static part of assembly 64 is preferably attached to or formed on structure 22. Assembly 64 can be actuated mechanically or electronically, as desired, for example, by a user interface 66 mounted on structure 22 (see FIG. 2). For mechanical actuation, user interface 66 can include a knob or handle, for electronic actuation, user interface 66 can include a touch screen or a set of buttons connected to a motor (not shown) that establishes the displacement and rotation.

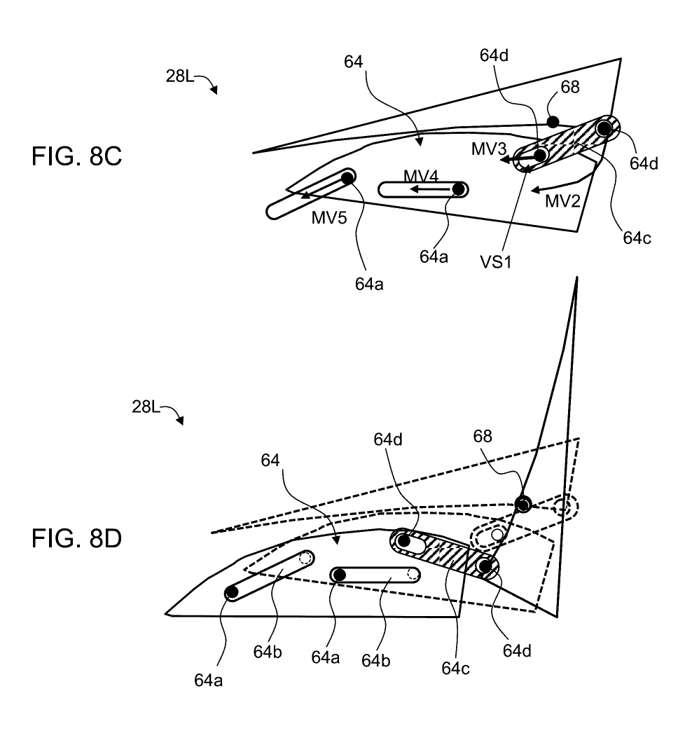

FIGS. 8A-D illustrates another embodiment suitable for a side-by-side view, wherein each of ocular systems 28 comprises a lens having the aspheric surface and a prismatic element positioned in front of the lens and being separated from the lens. The lenses of systems 28L and 28R are shown at 60L and 60R, respectively, and the prismatic elements of systems 28L and 28R are shown at 62L and 62R, respectively. The advantage of these embodiments for switching between a full screen view and a side-by-side view is that the prismatic elements can serve for providing a view of the entire screen of device 26 in the full screen view, and as a separator device in the side-by-side view, as will now be explained.

FIG. 8A illustrates system 20 in a full screen view configuration. Prismatic elements 62L and 62R are in front of lenses 60L and 60R such that light beams from the entire screen area of device 26 are refracted by elements 60L and 60R onto lenses 60L and 60R which in turn refract the light beams into eyes 30L and 60R. FIG. 8B illustrates system 20 in a side-by-side view configuration, suitable for viewing a stereoscopic image as further detailed hereinabove. In this configuration, lenses 60L and 60R are displaced toward the temporal side and toward frame 24 (not shown) holding display device 60, and are also rotated to the state at which their central optical paths are parallel to each other as further detailed hereinabove. Prismatic elements 62L and 62R are also displaced and rotated to assume a position generally along the symmetry line 52 between the left and right parts of display device 26, so as block a left light beam from the left part of display device from arriving at lens 60R, and a right light beam from the right part of display device from arriving at lens 60L.

In the present embodiments, ocular manipulation assembly 64 displaces lenses 60L and 60R toward the temporal side and toward frame 24, rotates lenses 60L and 60R, and also rotates prismatic elements 62L and 62R, preferably about a fixed axis 68 as is illustrated in FIGS. 8C and 8D. FIGS. 8C and 8D only show assembly 64 in relation to ocular system 28L. One of ordinary skills in the art, provided with the details described herein would know how to configure assembly 64 for ocular system 28R. Assembly 64 comprises pins 64a and guide slots 64b as further detailed hereinabove, and also includes a slidably rotatable linking member 64c linking lenses 60 with prismatic elements 62, for example, via support pins 64d formed or attached to the lenses and prismatic elements.

FIG. 8C illustrates the state of ocular system 28L in a full screen view configuration. The arrows MV2, MV3, MV4 and MV5 show the direction of motion of the respective pins in the transition from the first state (full screen view) to the second state (side-by-side view), and VS1 denotes a guide slot within member 64c guiding the motion MV3. FIG. 8D illustrates the second state of ocular system 28L (solid line), following the transition from the first state (dashed line). For clarity of presentation, the arrows MV2, MV3, MV4 and MV5 are not shown in FIG. 8D.

The amount of displacement of lenses 60 between the first and the second states is preferably about 10 mm, the amount of rotation of lenses 60 is preferably from about 10° to about 20°, e.g., about 15°, and the amount of rotation of prismatic elements 62 is preferably from about 90° to about 120°, e.g., about 105°.

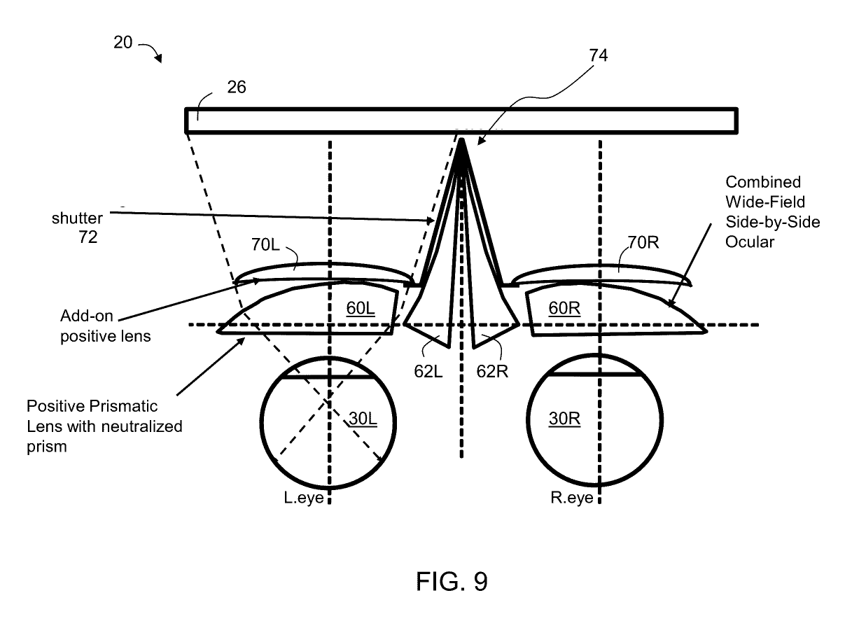

FIG. 9 is a schematic illustration of system 20 in embodiments in which system 20 comprises add-on positive lenses 70L and 70R, and optionally also a central shutter 72 covering at least the apex 74 formed by elements 62L and 62R once in the second state. It was found by the present Inventors that this improves the ability to view stereoscopic images. The add-on positive lenses 70L and 70R extend the field-of-view and the central shutter blocking undesired reflections from prismatic elements back onto display 16. Additionally or alternatively, the back surfaces of the prismatic elements can be coated by and anti-reflection coatings. Both lenses 70L and 70R and central shutter 72 can be made removable or foldable such that in full screen view they are not employed.

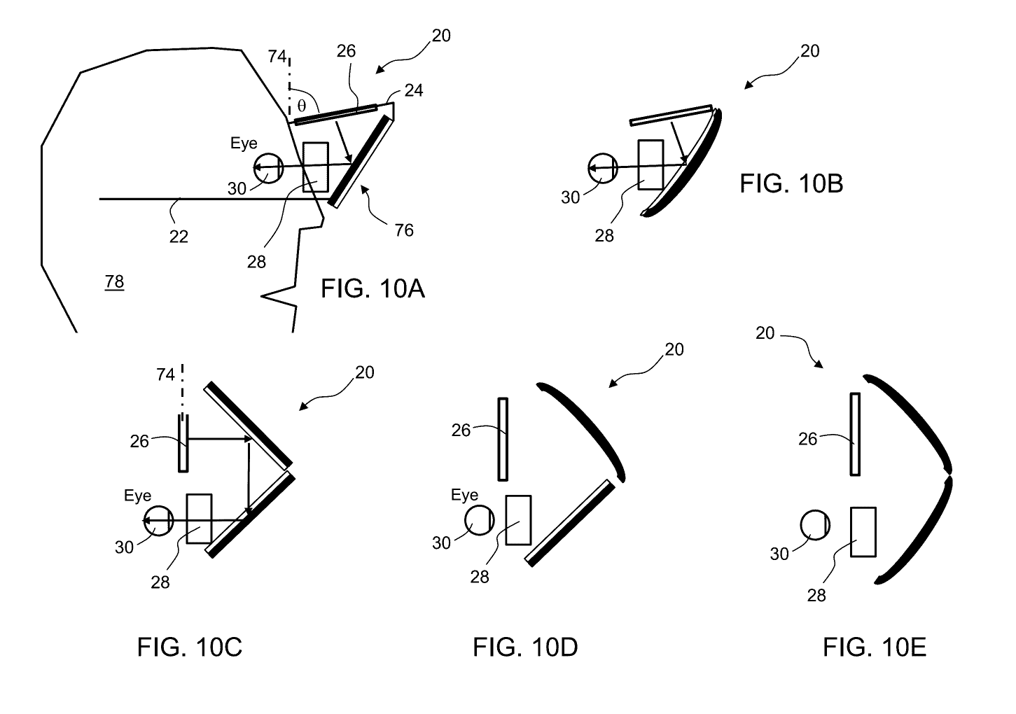

In the above embodiments, frame 24 and ocular systems 28 are arranged such that light beams from display device 26 directly arrive to at least one of ocular systems 28. However, this need not necessarily be the case since in some embodiments, it may be desired to have one or more pairs of reflective optical elements for redirecting light beams from display device 26 respectively onto the pair of ocular systems 28. These embodiments are illustrated in FIGS. 10A-E.

FIGS. 10A and 10B illustrates a side view of system 20 in an embodiment in which frame 24 is mounted on structure 22 such that when structure 22 is mounted on a head 78 in an upright position, frame 24 is tilted with respect to a vertical direction. The vertical direction is shown at 74, and the tilt angle is denoted θ. For clarity of presentation head 78, structure 22 and frame 24 are not illustrated in FIG. 10B. Typical values for θ are from about 40° to about 90°, more preferably from about 60° to about 85°. Light beams from display device 26 are directed generally downwards, and reflected by a pair of reflectors 76 positioned in front of eyes 30, in the direction of ocular systems 28. Since there is a single reflection, a flipped image is received. Thus, in various exemplary embodiments of the invention display device 26 performs image processing to provide a mirror image such that once the image arrives at ocular system 28 its direction is resorted.

FIGS. 10C-E illustrate a side view of system 20 in an embodiment that is similar to the embodiment shown in FIGS. 10A-B except that device 26 is mounted on frame generally vertically. In these embodiments, there is a plurality of pairs of reflectors 74 for redirecting the light downwards and then into ocular systems 28.

The configurations shown in FIGS. 10A-B is preferred from the standpoint of structural simplicity, and the configuration shown in FIGS. 10C-E is preferred from the standpoint of image processing simplicity. Reflectors 74 can be flat (FIGS. 10A and 10C), or they can be concaved (FIGS. 10B and 10E), for adding a positive diopter. Also contemplated are combinations of flat and concaved reflectors (FIG. 10D).

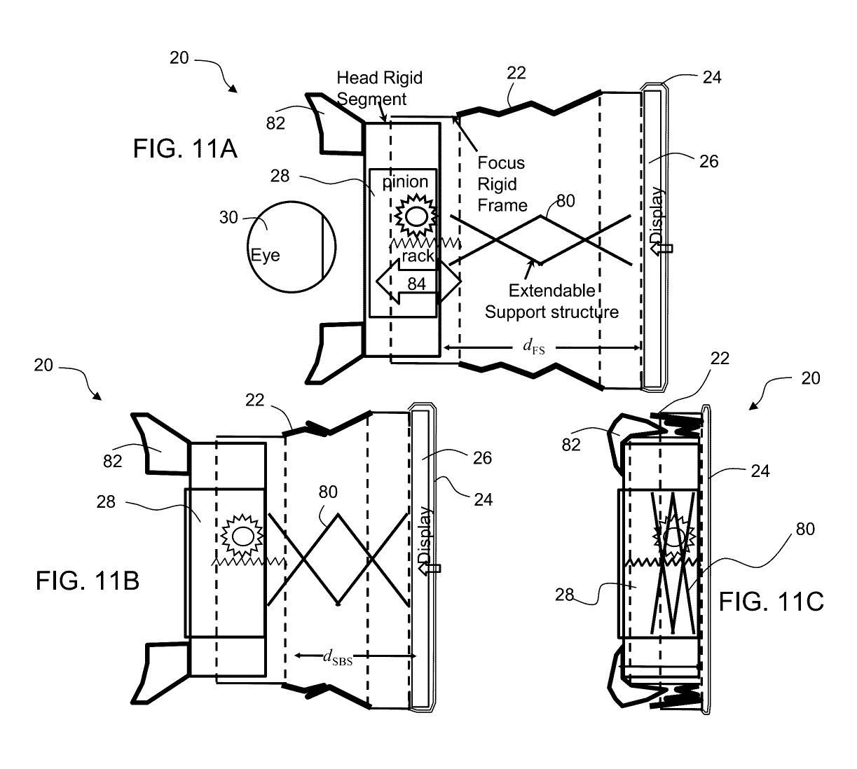

In some embodiments of the present invention structure 22 comprises a variable length support element 80 for supporting frame 24 at an adjustable optical distance from ocular systems 28. These embodiments are illustrated in FIGS. 11A-C. Element 80 can be, for example, an accordion spring, as illustrated in FIGS. 11A-C or a telescopic element (not shown). Also shown in FIGS. 11A-C is flexible structure 82 designed and constructed to be applied to the face, for allowing comfort wearing of system 20 and optionally and preferably also to block environmental light to bypass system 20 and enter eye 30. Preferably, ocular systems 28 are configured to adjust 84 their focal distance responsively to a variation of the optical distance between systems 28 and frame 24. In some embodiments of the present invention ocular manipulation assembly 84 (not shown in FIGS. 11A-C) actuates the aforementioned displacement and rotation responsively to the variation of the optical distance that can be implemented using any known technique, such as, but not limited to, rack and pinion mechanism as illustrated in FIGS. 11A-C, or any other motion regulation mechanism.

There are several advantages for employing a variable length support element. One advantage is that it can be utilized for effecting different distances in different view configuration. Preferably, element 80 provides larger distance between ocular systems 28 and frame 24 for full screen view configuration, than for side-by-side view configuration. This is because the area of display device that is viewable to each ocular systems 28 is larger in full screen view than in side-by-side view. Another advantage is that element 80 can be used for folding system 20, for example, for storage, carrying in a pocket of the like.

In FIGS. 11A-C, FIG. 11A illustrates an unfolded configuration which is suitable for full-screen view. At this configuration, the distance d_{FS} between systems 28 and frame 24 can be about 60 mm. FIG. 11B illustrates a partially folded configuration suitable for side-by-side view, wherein the distance between the display device 26 and ocular systems 28 is reduced. At this configuration, the distance d_{SBS} between systems 28 and frame 24 can be about 40 mm. FIG. 11C illustrates a completely folded configuration for storage. An additional compactification can be achieved by folding structure, as illustrated in FIG. 11. The thickness of system 20 in the folded configuration can thus be reduced to approximately equal the thickness of systems 28, with addition of several millimeters. Typically, system 20 can be folded to a thickness of about 20 mm.

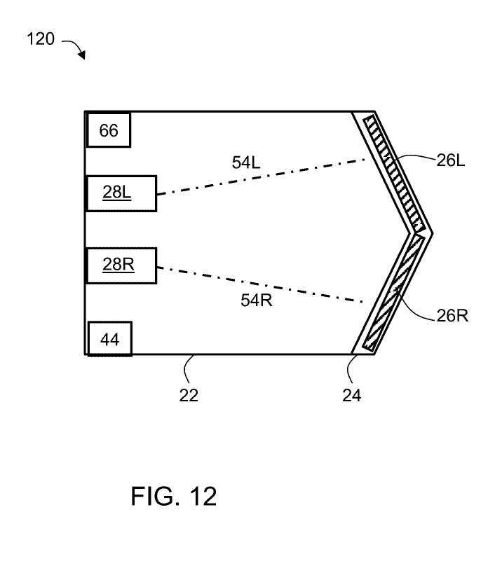

FIG. 12 is a schematic illustration of a display system 120, according to some embodiments of the present invention. Display system 120 comprises a head-mountable structure 22 having frame 24 configured to removably secure thereto a left display device 26L and a right display device 26R in a tilted relationship therebetween. Display devices 26L and 26R can be of any type described above with respect to device 26. System 120 optionally and preferably further comprises left ocular system 28L and right ocular system 28R, that respectively provide enlarged views of left and right display devices 26L and 26R. System 120 can further comprise a controller 44 and user interface 66 as further detailed hereinabove.

The construction of ocular systems 28 in system 120 can be similar to their construction in system 20, except that in system 120 the central optical paths 54L and 54R of ocular systems 28L and 28R diverge towards frame 24.

System 120 can be used for viewing an image that is complementary displayed on display devices 26L and 26R.

The terms “complementary,” as used herein in conjunction to images, refer to a combination of two images so as to provide the information required for substantially reconstructing the scene captured by both images.

The human visual system is known to possess a physiological mechanism capable of inferring a complete image based on several portions thereof, provided sufficient information reaches the retinas. This physiological mechanism operates on monochromatic as well as chromatic information received from the rod cells and cone cells of the retinas. Thus, in a cumulative nature, two views, reaching each individual eye, can form a combined field-of-view perceived by the user, which combined field-of-view is wider than the individual field-of-view provided to each eye. Thus, according to some embodiments of the present invention controller 44 controls display devices 26L to display different portions of the same image. By the aforementioned physiological mechanism a user viewing devices 26L and 26R through systems 28L and 28R can perceive the entire image even though none of devices 26L and 26R displays the entire image.

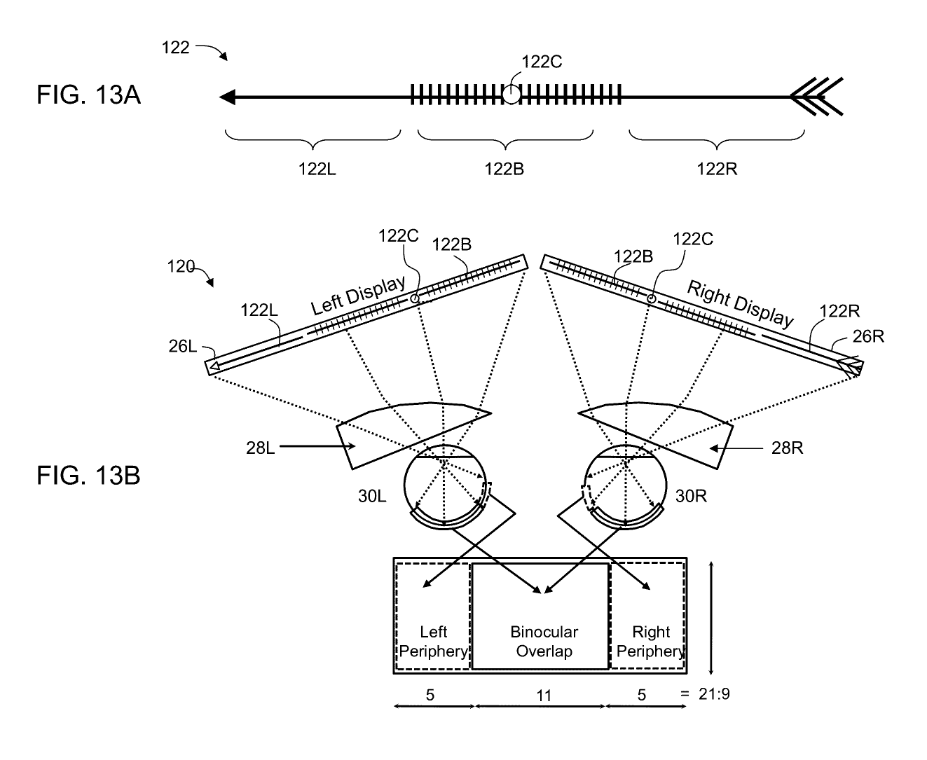

The situation can be better understood with reference to FIGS. 13A-B, which illustrates an image 122 (FIG. 13A) and the different portions of the image on each of devices 26L and 26R (FIG. 13B). Image 122 is defined in FIG. 13A as having three mutually exclusive portions that together form the entire image 122, namely the portions do not overlap and do not have gaps therebetween. The portions are referred to as a left periphery 122L, a binocular overlap 122B and a right periphery 122R. The center of binocular overlap 122B is shown at 122C. According to some embodiments of the present invention left display device 26L displays left periphery 122L and binocular overlap 12B, and right display device 26R displays binocular overlap 122B and right periphery 122R.

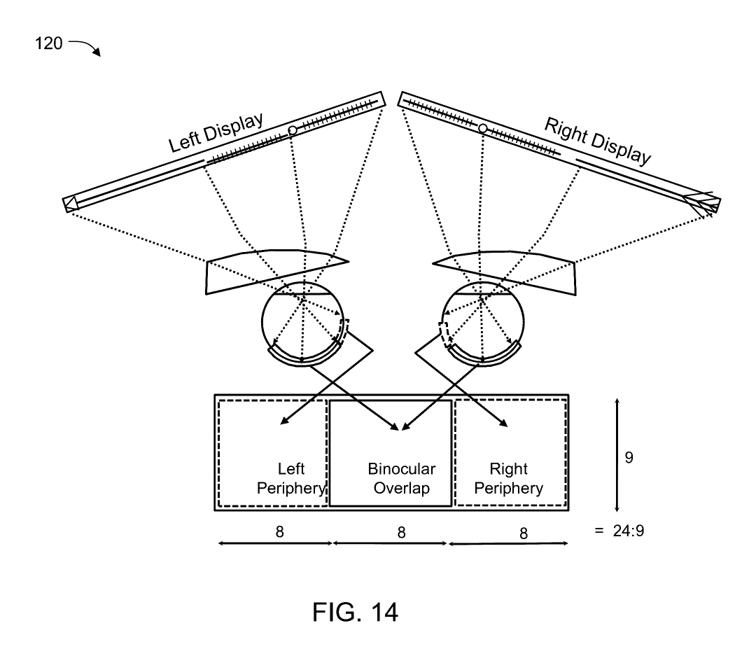

In the representative illustration of FIG. 13B, which is not to be considered as limiting, system 120 provides a 21:9 view using two 16:9 display devices. The binocular overlap 122B that is displayed by both display devices forms 11/21 of the width of the image and each of the right and left periphery forms 5/21 of the image. FIG. 14 illustrates a configuration in which system 120 provides a 24:9 view using two 16:9 display devices. The binocular overlap that is displayed by both display devices forms ⅔ of the width of the image and each of the right and left periphery forms ⅓ of the image. Other ratios are also contemplated. The relative proportions of the binocular overlap and the peripherals are optionally and preferably determined based on the prismatic power of systems 28L and 28R.

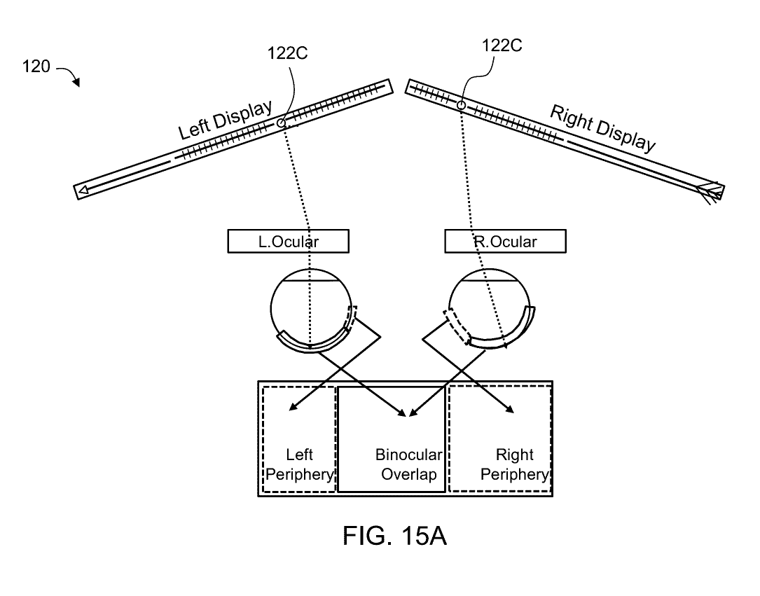

Some embodiments also provide a solution to the problems of muscular imbalance or eccentric fixation by the eyes. In these embodiments, the user operates user interface 66 for signaling controller 44 to shift a location of the binocular overlap over one or more of display devices 26L and 26R. FIG. 15A illustrates an embodiment in which systems 120 adapts for a condition in which there is an eccentric fixation by the right eye. The right eye gaze is straight, but its fixation point is shifted by a certain amount (e.g., 10°) from the fovea. In these embodiments, the central point 122C of binocular overlap 122B is shifted toward the left end of the right display, thereby reducing or preventing diplopia. FIG. 15B illustrates an embodiment in which systems 120 adapts for a condition in which there is a muscular imbalance by right eye. The right eye gaze is shifted leftwards due to strabismic condition, but a central fixation is preserved. In these embodiments, the central point 122C of binocular overlap 122B is shifted toward the right end of the right display so as to allow the right eye to be in rest condition without diplopia.

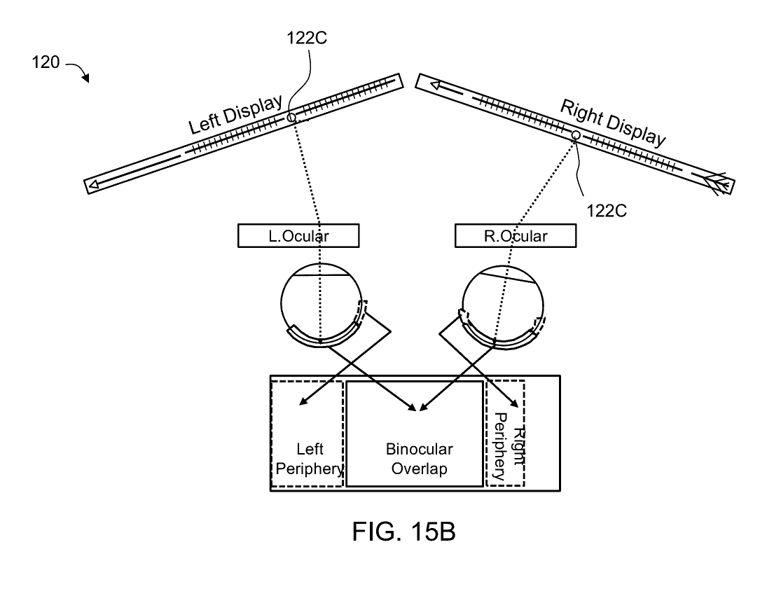

FIG. 16 illustrates system 120 in embodiments in which system 120 comprises a separator device 50 mounted on structure 22 (not shown in FIG. 16, see FIG. 12) along a symmetry line 52 between the left 26L and right 26R display devices, so as to block light beams from the left display device from arriving at right ocular system 28R, and light beams from the right display device from arriving at left ocular system 28L. It was found by the present Inventor that the viewing experience is enhanced by providing separator 50 as a back-to-back pair of auxiliary display devices 124L and 124R. Light beams from auxiliary display device 124L arrive at ocular system 28L and light beams from auxiliary display device 124R arrive at ocular system 28R. Optionally, the pixel density of auxiliary display devices 124 is less than the pixel density of devices 26 since peripheral vision is less important for image recognition and is mostly for situation awareness. In various exemplary embodiments of the invention controller 44 controls left auxiliary display device 124L to display right periphery 122R, and right auxiliary display device 124R to display left periphery 122L. The advantage of using auxiliary display device 124 is that they provide immersive view with reduced or substantially without discontinuity.

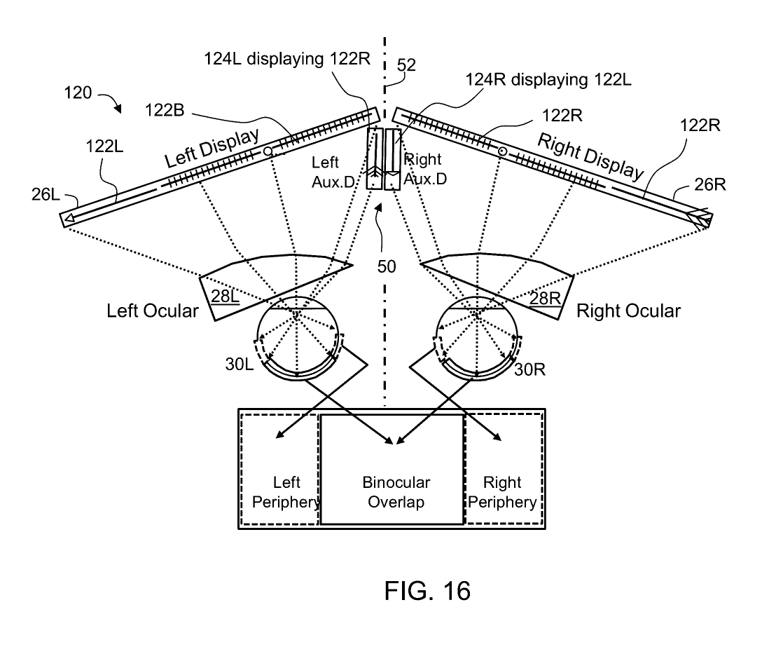

FIGS. 17A and 17B illustrate system 120 in embodiments of the invention in which system 120 comprises a pair of controllable light shutters 46L and 46R respectively positioned between ocular systems 28L and 28R and devices 26L and 26R. These embodiments are also useful for providing immersive view with reduced or substantially without discontinuity, and are therefore preferably employed as a substitute to auxiliary display devices 124.

Controller 44 receives synchronization signals from display devices and activates and deactivates light shutters 46 in an alternating manner, responsively to the synchronization signals. Referring more specifically to FIGS. 17A and 17B, when shutter 46L is open and shutter 46R is closed (FIG. 17A), left display device 26L displays the left periphery 122L and binocular overlap 122B, and right display device 26R displays, at its left portion that is within the field-of-view of left ocular system 28L, the right periphery 122R. Conversely, when shutter 46R is open and shutter 46L is closed (FIG. 17B), right display device 26R displays the binocular overlap 122B and right periphery 122R, and left display device 26L displays, at its left portion that is within the field-of-view of right ocular system 28R, the left periphery 122L.

The rate of alternation between the closing and opening of shutters is preferably at a rate that is twice the rate of a two-dimensional video image (for example, twice a rate of 60 Hz), so that each eye receives a frame sequence at a rate of a two-dimensional video image, thus providing an illusion as if the two displays are viewed simultaneously.

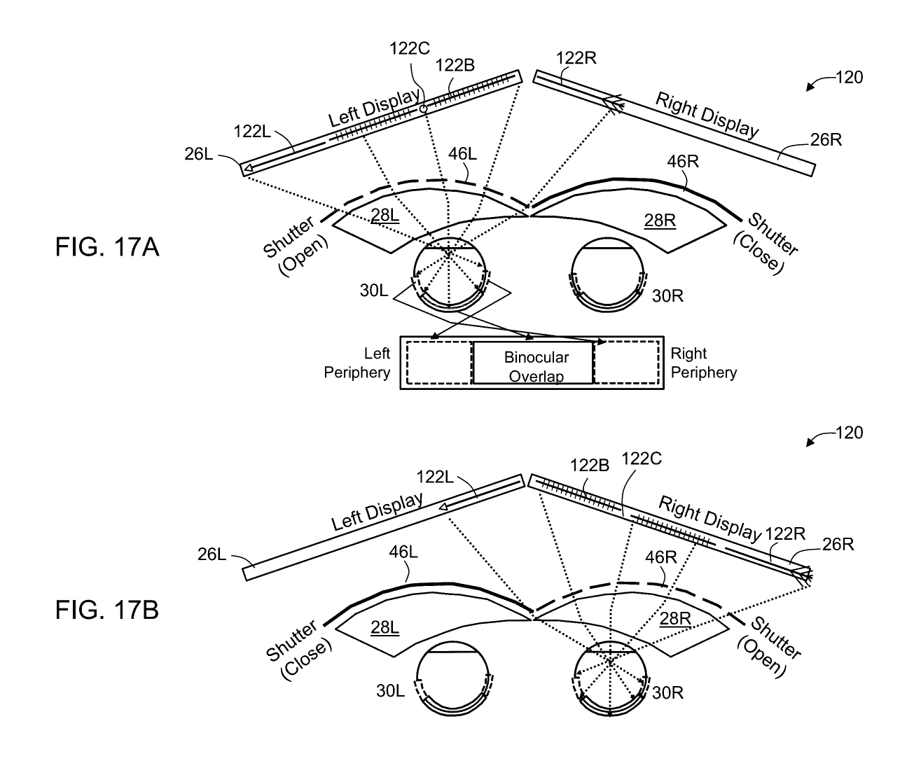

FIG. 18 is a schematic illustration of a display system 180 which comprises side auxiliary display devices, according to some embodiments of the present invention. System 180 comprises structure 22 having frame 24 configured to removably secure display device 26. System 180 further comprising a plurality of auxiliary display devices mounted on structure 22 at an angle to a plane engaged by frame 24. In the illustration shown in FIG. 18, which is not to be considered as limiting, system 18 comprises a left auxiliary display device 182L and a right auxiliary display device 182R. Optionally, the pixel density of auxiliary display devices 182 is less than the pixel density of devices 26.

System 180 further comprises a left ocular system 184L and right ocular system 184L, which are mounted on structure 22 in front of frame 24 and auxiliary display devices 182L and 182R. Left 184L and right 184R ocular systems can have similar optical properties as systems 28L and 28R above, but this is not necessary. In various exemplary embodiments of the invention ocular systems 184 do not include an aspheric surface, and in various exemplary embodiments of the invention ocular systems 184 are not prismatic. In any event systems 28L and 28R are designed and constructed such that the field-of-view of left ocular system 184L includes at least left auxiliary display device 182, and the field-of-view of right ocular system 184R includes at least right auxiliary display device 182R. Preferably, the field-of-view of each of ocular systems 184 also includes half of the area of display 26 (or half of the area of frame 24), so as to allow side-by-side view of stereoscopic images.

System 180 further comprises controller 44 and user interface 66. System 180 is particularly useful for displaying a stereoscopic image in a side-by-side configuration. The stereoscopic image can include a stereoscopic left periphery 200, a stereoscopic binocular overlap 202 and a stereoscopic right periphery 204. Each of these portions 200, 202 and 204 of the stereoscopic image is also stereoscopic, and therefore includes a left-eye and a right-eye image versions corresponding to different viewpoints from which the respective image version. These left-eye and right-eye image versions are labeled by the letters L and R. Thus, stereoscopic left periphery 200, has a left-eye image version denoted 200L and a right-eye image version denoted 200R, and so on.

Controller 44 preferably controls display 26 to display on its left part the left-eye image 202L of the stereoscopic binocular overlap 202 and on its right part the right-eye image 202R of the stereoscopic binocular overlap 202. Optionally, controller 44 also displays on the left part of controls display 26 the left-eye image 204L of the stereoscopic right periphery, to the right of image 202L, and on the right part of controls display 26 the right-eye image 200R of the stereoscopic left periphery 200, to the left of image 202R.

Controller 44 also controls display 182L to display the left-eye image 200L of the stereoscopic left periphery 200, and display 182R to display the right-eye image 204R of the stereoscopic right periphery 204.

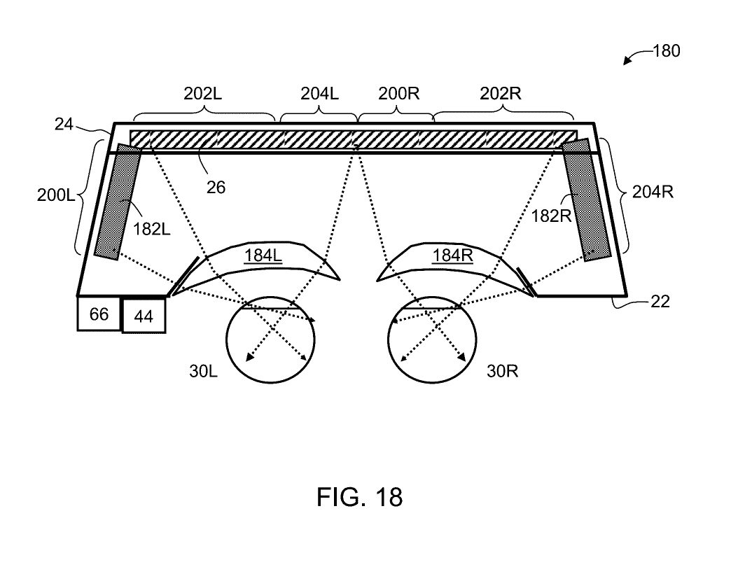

FIG. 19 is a schematic illustration of display system 180 in embodiments in which system 180 comprises four auxiliary display devices, according to some embodiments of the present invention. In the illustrated embodiment, system 180 comprises, in addition to auxiliary display devices 182L and 182R, a central-left auxiliary display device 186L and a central-right auxiliary display device 186R. Devices 286L and 286R are mounted on structure 22 along a symmetry line 52 between the left and right halves of display device 26, preferably to block light beams from the left part of display device 26 from arriving at right ocular system 184R, and light beams from the right part of display device 26 from arriving at left ocular system 184L. When central-left 186L and central-right 186R auxiliary display devices are employed they can be utilized to display the peripheral portion of the stereoscopic image. Specifically, controller 44 can control display 186L to display image 204L and display 186R to display image 200R. In these embodiments, images 204L and 200R are preferably not displayed by device 26, thereby allowing each of images 202L and 202R to occupy a larger portion of device 26 (e.g., image 202L can occupy the left half of display 26, and image 202R can occupy the right half of display 26).

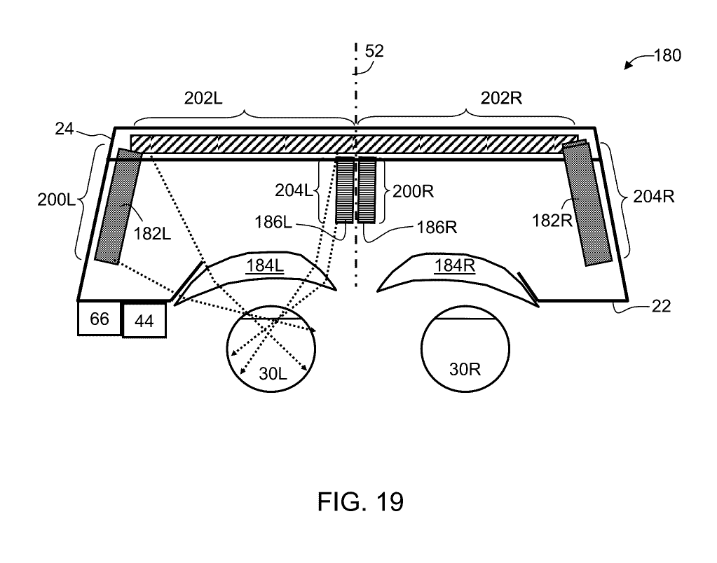

System 180 can be used for providing a wide screen illusion of stereoscopic images. FIG. 20 illustrates a representative implementation of system 180 for providing a 21:9 aspect ratio 3D image using a 16:9 display. Other aspect ratios are also contemplated.

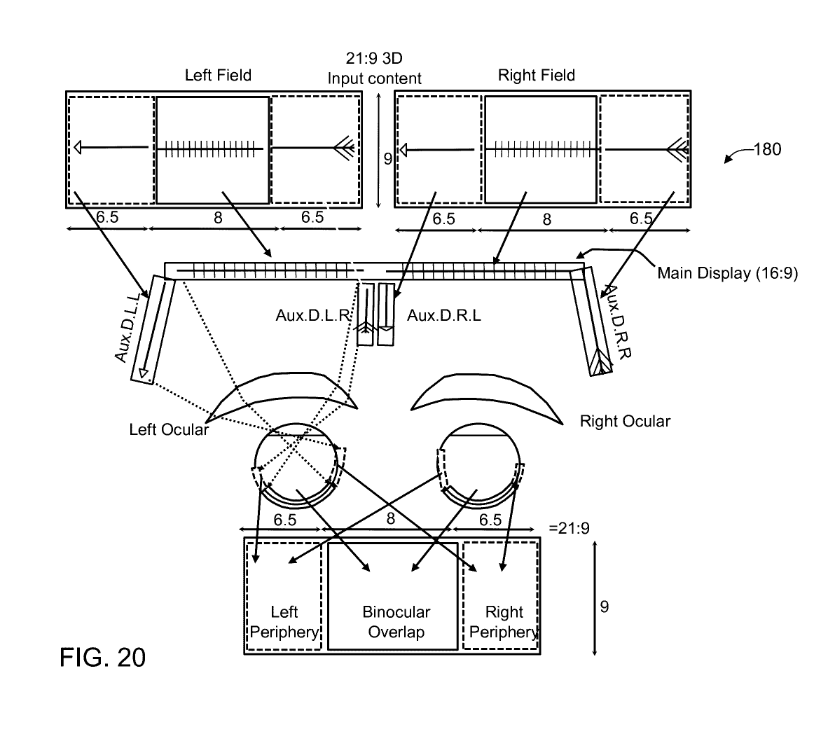

FIG. 21A-C are schematic illustrations of a display system 210 useful for augmented reality, according to some embodiments of the present invention. System 210 can employ any of the features and techniques described above with respect to systems 20, 120 and 180. In various exemplary embodiments of the invention system 210 comprises structure 22 having frame 24 configured to removably secure display device 26 thereto, such that when structure 22 is mounted on head 78, frame 24 is above the eyes. Device 26 optionally and preferably has a back camera 26′. In some embodiments of the present invention system 210 comprises device 26.

System 210 further comprises an optics assembly 212 mounted on structure 22 and being partially reflective and partially transmissive for simultaneously providing a view of an image displayed on display device 26 and a view 216 of an environment 218 outside structure 22. For clarity of presentation, the image displayed on device 26 is not illustrated. A light beam constituting the displayed image is represented by arrow 214.

Optionally and preferably, system 210 provides a side-by-side view which is particularly useful for augmented reality implementation. In these embodiments, system 210 may comprise separator device 50, which can be embodied according to any of the teachings described above (opaque wall, prismatic elements, auxiliary display devices) mounted on structure 22 along a symmetry line (not shown) between the left and right parts of display device 26, so as to block light beams from the left part of display device 26 from arriving at the right eye, and light beams from the right part of display device 26 from arriving at the left eye.

FIG. 21A illustrates a side view of system 210 in an embodiment in which frame 24 is mounted on structure 22 such that when structure 22 is mounted on head 78 in an upright position, frame 24 is tilted at tilt angle θ with respect to vertical direction 74, as further detailed hereinabove. Light beams from display device 26 are directed generally downwards, and reflected by optics 212 in the direction of eyes 30. Since there is a single reflection, a flipped image is received. Thus, in various exemplary embodiments of the invention display device 26 performs image processing to provide a mirror image such that once the image arrives at ocular system 28 its direction is resorted.

FIGS. 21B and 21C illustrate a side view of system 210 in an embodiment that is similar to the embodiment shown in FIG. 21A except that device 26 is mounted on the frame generally vertically (head 78, structure 22 and frame 24 not shown, for clarity of presentation). In these embodiments, optics 212 includes a plurality of pairs of reflectors for redirecting the light downwards and then into eyes 30.

The configurations shown in FIG. 21A is preferred from the standpoint of structural simplicity, and the configuration shown in FIGS. 21B-C is preferred from the standpoint of image processing simplicity.

In various exemplary embodiments of the invention optics assembly 212 converges light beams 214 arriving from display device 26 but not light beams 216 arriving from environment 218. This can be achieved in more than one way.

In some embodiments, a partially reflective (and partially transmissive) concave mirror 220 (see FIG. 21A). Light beam 214 is reflected by the concave side of mirror 220 and is therefore converged following the reflection. Light beam 216 first arrives at the convex side of mirror 220 and is divergent while passing through the body of mirror 220 but is then converged by the concave surface at the other side. Thus, according to some embodiments of the present invention the concave and convex surfaces of mirror 220 have the same radius of curvature so that the convergence by the concave surface cancels the divergence by the convex surface.

In some embodiments, a combination of a reflective mirror 222 and a partially reflective (and partially transmissive) flat surface 224 is employed (see FIG. 21B). Light beam 214 is reflected by the concave side of mirror 222 to form a converged beam 214′ propagating towards surface 224. Light beam 214′ is then reflected by flat surface 224 which is neutral with respect to convergence or divergence. Light beam 216 passes through flat surface 224 and is not converged or diverged due to the neutrality of surface 224.

Also contemplates, are embodiments in which beam 214 is converged twice, as illustrated in FIG. 21C. In these embodiments, optics 212 comprises reflective concave mirror 222 and partially reflective (and partially transmissive) concave mirror 220, wherein light beam is first reflected from mirror 222 and then from mirror 220, and light beam 216 passes through mirror 220.

In various exemplary embodiments of the invention structure 22 comprises a variable length support element 80 (shown in FIG. 21A) for supporting frame at an adjustable optical distance d (shown in FIGS. 21B and 21C) from optics assembly 212, thereby to effect focal distance adjustment for light beams 214 arriving from display device 26.

In various exemplary embodiments of optics assembly 212 comprises a reflecting element 226 for redirecting light beam 216 arriving from environment 218 onto the back side of display device 26. Preferably, element 226 is constituted to reflect the beam onto the back camera 26′ of device 26. A particular advantage of the present embodiments is that it allows camera 26′ to capture a scene from the forward direction with respect to head 78. Since structure 22 is head mounted, the forward direction dynamically varies with the motion of the head so that camera 26′ substantially captures images of objects in the gaze direction of the user. The data processor of display device 26 can identifies objects in the scene and can add virtual objects to be displayed in an overlaid manner with the objects captured from the scene.

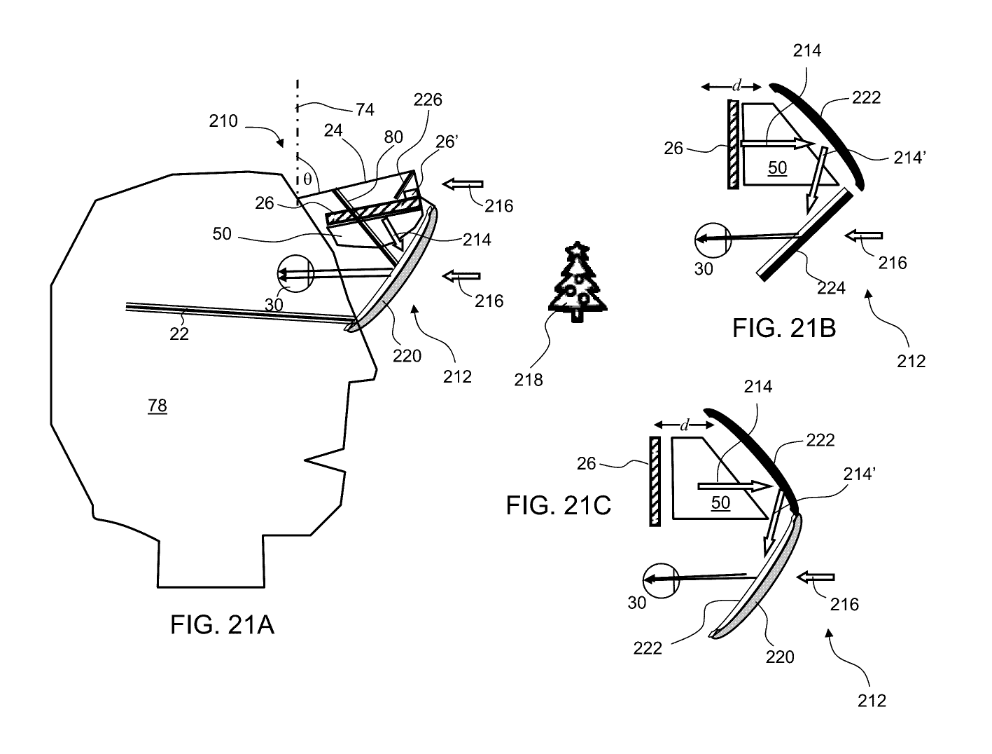

Reference is now made to FIGS. 22A-D which are schematic illustrations of a method suitable for varying an aspect ratio of an image, according to some embodiments of the present invention. The method can be use for processing an image before being viewed by any of the systems described herein.

The method can be embodied in many forms. For example, it can be embodied in on a tangible medium such as a computer for performing the method operations. It can be embodied on a computer readable medium, comprising computer readable instructions for carrying out the method operations. It can also be embodied in an electronic device having digital computer capabilities arranged to run the computer program on the tangible medium or execute the instruction on a computer readable medium. A representative example of such an electronic device is data processor of a mobile device, such as, but not limited to, a smartphone or a tablet device.

Computer programs implementing the method according to some embodiments of this invention can commonly be distributed to users on a distribution medium such as, but not limited to flash memory devices, flash drives, or, in some embodiments, drives accessible by means of network communication, over the internet (e.g., within a cloud environment), or over a cellular network. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this invention. Computer programs implementing the method according to some embodiments of this invention can also be executed by one or more data processors that belong to a cloud computing environment. All these operations are well-known to those skilled in the art of computer systems. Data used and/or provided by the method of the present embodiments can be transmitted by means of network communication, over the internet, over a cellular network or over any type of network, suitable for data transmission.

It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method can be utilized for two-dimensional as well as for stereoscopic images. The method is particularly useful for solving the problem of cropping of wide images when displayed on a screen having a different aspect ratio than the original image. For example, when a display device receives an input image having an aspect ratio that is compatible with the size of the device's screen, and it is desired to display the image on a sub-area of the screen with a different aspect ratio (e.g., in a side-by-side view configuration), it is required to either crop the image or to resize it to a size that is smaller than the desired sub-area.

In a search for a solution to this problem, the present Inventor realized that certain regions over the image that are of less interest to the average viewer can be resized relative to other regions that are of greater interest to the average user.

Referring to FIGS. 22A-D, FIG. 22A illustrates the input image. In the exemplified illustration, a stereoscopic image, having left-eye viewable features 230 and right-eye viewable features 232, but the method can also be employed for two-dimensional images, depth images, or any other type of image. A two or more regions are identified on the image. In the illustrated example, three regions are identified, a central region 234, a left peripheral region 236 and a right peripheral region 238, but any number of regions can be identified.

The image is then processed to vary the aspect ratio of regions 236 and 238 while maintaining the aspect ratio and optionally also the size of region 234 substantially unchanged. The aspect ratio is varied by stretching or squeezing the region along at least one direction of the image such that the height to width ratio before processing differs from the height to width ratio after processing. This operation is illustrated in FIGS. 22B and 22C for the left-eye image and the right-eye image, respectively. This effects a variation of the aspect ratio of the image. The method then transmits the processed image as an output image to a computer readable medium or displays the image on a screen of a display device, as illustrated in FIG. 22D. In some embodiments of the present invention the resizing of regions 236 and 238 is while preserving their aspect ratio, and in some embodiments of the present invention the resizing of regions 236 and 238 effects a change in the aspect ratio. Preferably the processing is executed such that the relative aspect ratio of at least one two regions in the image changes.

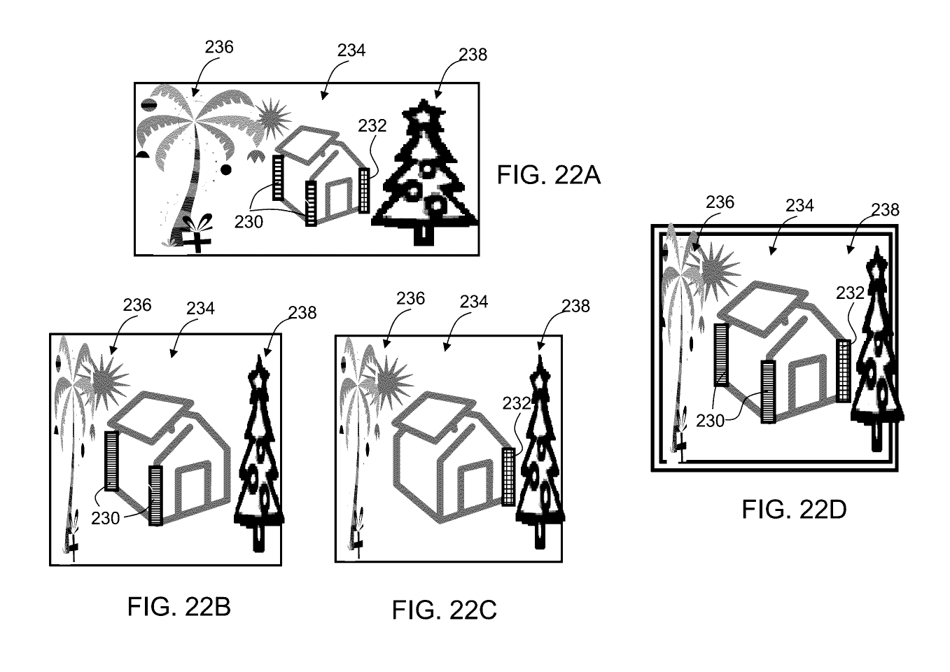

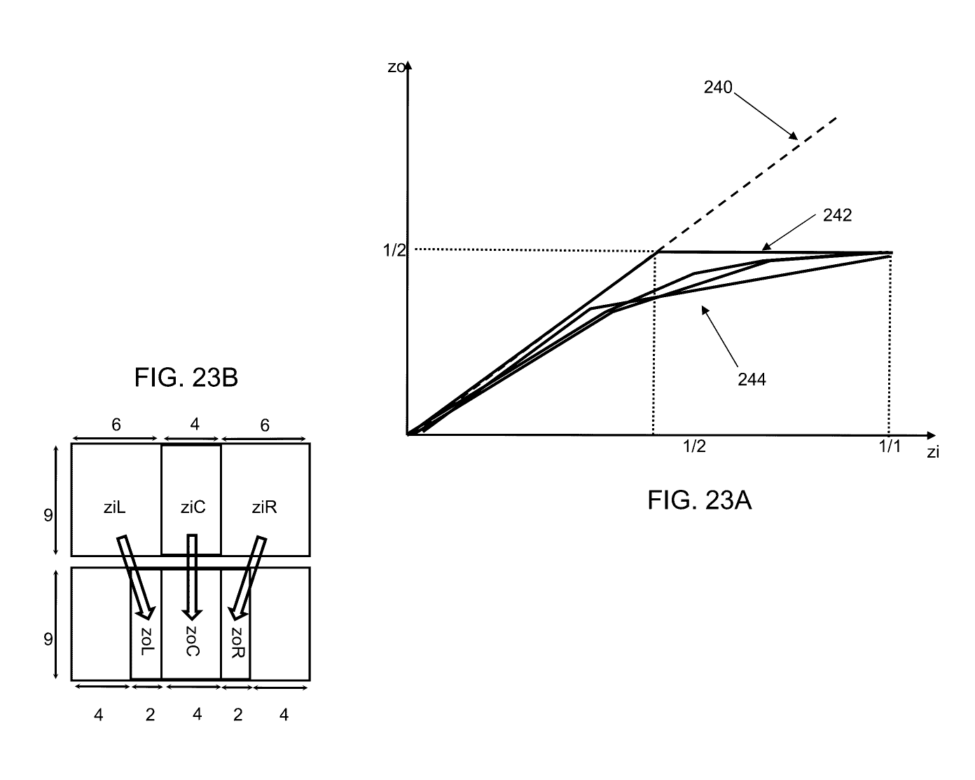

The method of the present embodiments thus utilize an aspect ratio variation that is nonlinear or piecewise linear as a function of the image's coordinate, as illustrated in the graph of the output image as a function of the input image shown FIG. 23A. In FIG. 23A zi is a horizontal coordinate along the input image, normalized to unity, and zo is a horizontal coordinate along the output image, normalized to unity. Line 240 corresponds to a case in which the aspect ratios of the input and output images is the same. Line 242 corresponds to a typical 50% cropping operation (25% from each side), and the three lines shown generally at 244 correspond to a nonlinear or piecewise linear variation of the aspect ratio according to some embodiments of the present invention.

A representative implementation example of the method of the present embodiments for varying an aspect ratio of an input image is illustrated in FIG. 23B. In the illustrated example, the input image has an aspect ratio of 16:9 and the output image has an aspect ratio of 8:9. The identified regions on the input image are an input left peripheral region ziL having an aspect ratio of 6:9, a central region ziC having an aspect ratio of 4:9, and a right peripheral region ziR having an aspect ratio of 6:9. The regions ziL and ziR are processed to provide output left peripheral regions zoL and zoR, respectively, each having an aspect ratio of 2:9. The central region is unmodified so that the output central region zoC is the same as region ziC.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### Examples

Reference is now made to the following examples, which together with the above descriptions illustrate some embodiments of the invention in a non limiting fashion.

### Optical Design Considerations

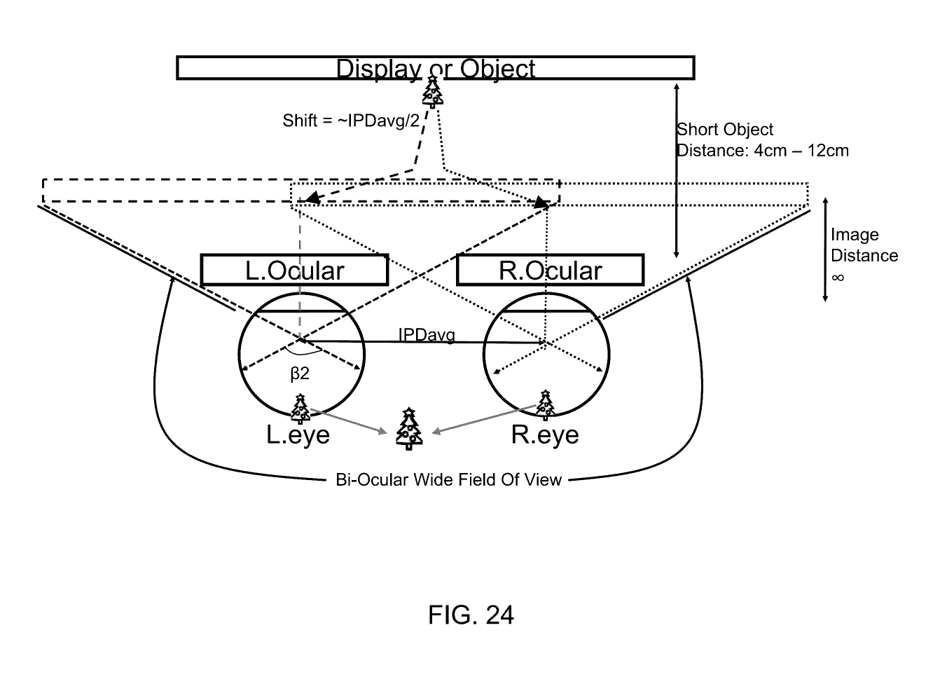

FIG. 24 is a schematic illustration describing some design consideration with respect to the systems described above.

It is desired to employ oculars that shift the optical center of the display to the left to allow easy gaze (ideally, but not necessarily straight) for the left eye, and the optical center of the display to the right to allow easy gaze (ideally, but not necessarily straight) for the right eye.

Preferably, but not necessarily, the systems are configured to allow viewing of at least 4″ screens (e.g., 4-6″) having standard aspect ratio of 16:9, with maximal angular field of view by lens power. It is preferred to provide easy convergence for the eyes, at least for the center points. Representative example is a 1.5° convergence, for IPD of 63 mm, equal to a 26.5 cm non-aided eye distance. It is recognized that convergence chromatic aberrations may evolves due to prismatic shift in horizontal direction. In order to reduce horizontal chromatic aberrations, the ocular systems are preferably designed such that a smear for originally white pixel (combined from RGB sub-pixels) along the horizontal dimension of the screen smear is extended over a single neighboring pixel or less.

The left and right peripheral points are of the present embodiments within the field-of-view and approximately equidistant from the central point.

The aspheric surface can be designed, e.g., by zernike polynomials to allow focusing to all points despite the different distances. Preferably, a 6 mm pupil diameter is used in the calculation of the surface such that the light rays cover the entire active surface area of the lens that provides focusing of the different points on the retina. Following the calculation, the pupil can be changed to about 3 mm diameter, which is typical pupil size under relevant illumination level, in order to make visual performance analysis.

The systems of the present embodiments are preferably designed for IPD distance of about 62 mm. The lens extreme nasal point is preferably about 3 mm from the center to allow IPD adjustment within the range of 56 mm to 62 mm.

### Electronic Design Considerations

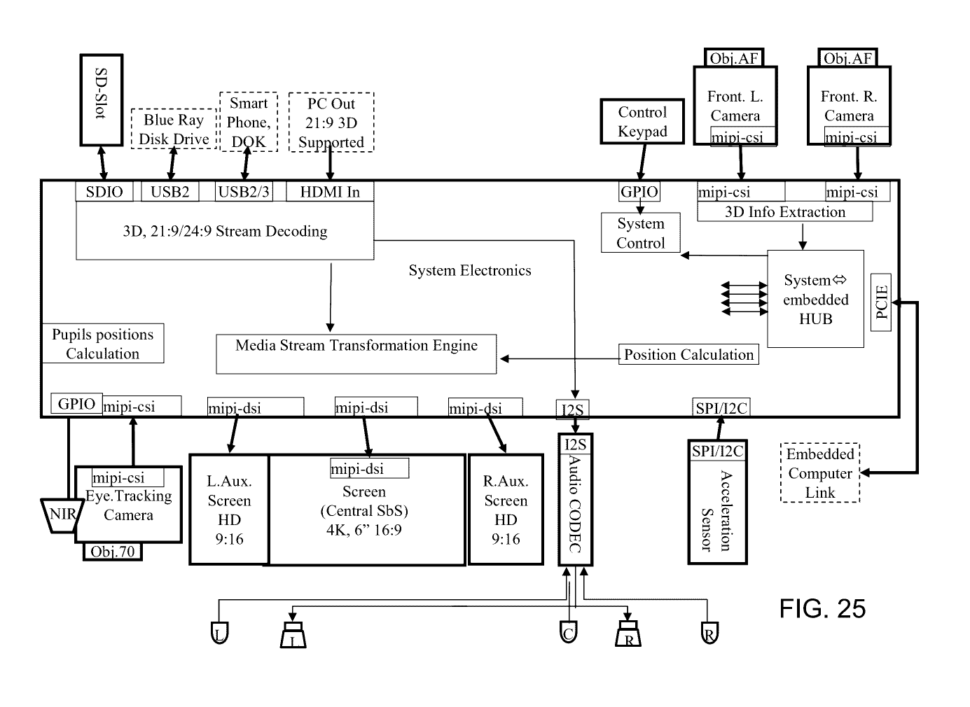

FIG. 25 illustrates an electronic circuitry layout that can be used by the controller 44 in any of systems described above. Optionally and preferably, the circuitry is employed by system 180 for enabling immersive view using single central display device through preferred MIPI-DSI interface. The Left and Right auxiliary displays are preferably connected through MIPI-DSI interface as well.

The circuitry can decode a stream of video frames, such as blue-ray 3D images, or cinematic 21:9 3D or 24:9 3D content as well as stream coming from SD Card, Smartphone, Disk-on-Key or and Media Player. The decoded stream passes through a Media Stream Transformation Engine that transcodes the stream to the Central and Auxiliary displays, as described above with reference to FIGS. 13-20. For a wider content, for example, a 360° content, acceleration sensors, preferably connected through I2C or SPI interfaces, track the head or body motion (preferably rotation), via a position calculation engine, and the portion of content corresponding to angle of view is selected from the decoded stream and/or content corresponding to viewed angel is retrieved from the media for decoding and transcoding.

In addition the system can have an Eyes tracking camera, preferably connected through an MIPI-CSI with a near infrared (NIR) illumination, that is preferably operated via General-purpose input/output (GPIO), for various applications while the electronic system can have Pupils position calculation engine. The system can optionally also interface Front left and right cameras with auto-focus mechanisms, which are preferably connected through MIPI-CSI interfaces for either video capturing, augmented reality or 3D info extraction from the scene. The system can also interconnect with keyboard/mouse through USB or GPIOS and embedded computer, preferably via a Peripheral Component Interconnect Express (PCIE) interface.

The system may also be equipped with Audio CODEC to receive voice commands or record sounds and for generation of sounds. The system is preferably connected through an I2S interface to the system electronics.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-103. (canceled)

104. An ocular system for providing an eye with a view of an object, the ocular system comprises an aspheric optical surface and provides a prismatic refraction, wherein the aspheric optical surface and prismatic refraction are selected to shift an optical center of the object towards a temporal side of the eye, while keeping in focus all points of the object.

105. The system according to claim 104, wherein said aspheric optical surface and an opposite surface of said ocular system are spaced apart from each other at a nasal portion of a periphery of said ocular system by a cut through a thickness thereof.

106. The system according to claim 104, comprising a vision correction lens.

107. An optical magnification system comprising:
a structure having a frame configured to secure an object thereto; and
a pair of spaced apart ocular systems, mounted on said structure in front of said frame for providing a view of said object once mounted on said frame;
wherein each of said ocular systems comprises the ocular system according to claim 104.

108. The system according to claim 107, wherein each of said ocular systems comprises a vision correction lens, and wherein a refractive power of a vision correction lens of a first lens system of said pair differ from a refractive power of a vision correction lens of a second lens system of said pair.

109. The system according to claim 107, further comprising:
a pair of controllable light shutters respectively positioned between said ocular systems and said frame; and
a controller having a circuit configured for receiving synchronization signal from said display device and activating and deactivating said light shutters in an alternating manner, responsively to said synchronization signal.

110. The system according to claim 107, further comprising an ocular manipulation assembly configured for displacing and rotating each of said ocular systems.

111. The system according to claim 107, wherein said frame and said ocular systems are arranged such that light beams from said object directly arrive to at least one of said ocular systems.

112. The system according to claim 107, further comprising at least one pair of reflective optical elements configured for redirecting light beams from said display device respectively onto said pair of ocular systems.

113. A method of an object, the method comprising securing a object to the system according to claim 107, placing said structure near the eyes, and viewing said object through said ocular systems.

114. A method of viewing an image displayed on a display device, the method comprising:
securing the display device to a structure having a frame configured to secure the display device thereto; and
viewing the image through a pair of spaced apart ocular systems mounted on said structure in front of said frame, wherein each of said ocular systems has an aspheric optical surface and provides a prismatic refraction.

115. An ocular system for providing an eye with a view of an object, the ocular system comprises an aspheric optical surface and provides a prismatic refraction, wherein the aspheric optical surface and prismatic refraction are selected to shift an optical center of the object towards a nasal side of the eye, while keeping in focus all points of the object.

116. A display system comprising:
a structure having a frame configured to removably secure thereto a left display device and a right display device in a tilted relationship therebetween; and
a left ocular system and right ocular system, mounted on said structure in front of said frame such that central optical paths of said ocular systems diverge towards said frame to respectively provide enlarged views of said left and said right display devices;
wherein each of said ocular systems comprises the ocular system according to claim 115.

117. The system according to claim 116, further comprising a controller having a circuit for controlling said display devices to display different portions of an image having a left periphery, a binocular overlap and a right periphery, wherein said left display device displays said left periphery and said binocular overlap, and said right display device displays said binocular overlap and said right periphery.

118. The system according to claim 117, wherein said controller comprises a user interface and wherein circuit is configured for shifting a location of said binocular overlap over at least one of said display devices, responsively to a user input received by said user interface.

119. The system according to claim 118, further comprising a separator device, mounted on said structure and having a back-to-back pair of auxiliary display devices, and wherein light beams from a left auxiliary display device of said pair arrive at said left ocular system, and light beams from a right auxiliary display device of said pair arrive at said right ocular system.

120. The system according to claim 116, further comprising:
a pair of controllable light shutters respectively positioned between said ocular systems and said frame; and
a controller having a circuit configured for receiving synchronization signal from said display device and activating and deactivating said light shutters in an alternating manner, responsively to said synchronization signal.

121. The system according to claim 116, wherein said structure comprises a variable length support element for supporting said frame at an adjustable optical distance from said pair of ocular systems, and wherein said ocular systems are configured to adjust a focal distance thereof responsively to a variation of said optical distance.

122. The system according to claim 116, wherein at least one of said each of said ocular systems comprises a vision correction lens.

123. A method of viewing an image, the method comprising securing a left display device and a right display device to the system according to claim 116, placing said structure near the eyes, and viewing said display devices through said ocular systems.
